(19) United States
(12) Patent Application Publication
(10) Pub. No.: US 2020/0338591 A1
(43) Pub. Date: Oct. 29, 2020

(54) METHOD FOR FORMING MULTI-LAYER COATING FILM

(71) Applicant: KANSAI PAINT CO., LTD., Hyogo (JP)

(72) Inventors: Kenji SAKAI, Kanagawa (JP); Teruo SASAKI, Kanagawa (JP); Natsuko NAKANO, Kanagawa (JP)

(73) Assignee: KANSAI PAINT CO., LTD., Hyogo (JP)

(21) Appl. No.: 16/962,163

(22) PCT Filed: Jan. 11, 2019
(86) PCT No.: PCT/JP2019/000753

§ 371 Date: Jul. 14, 2020

(30) Foreign Application Priority Data
Jan. 15, 2018 (JP) 2018-003959

(51) Int. Cl. B05D 5/06; B05D 7/00; B05D 1/36; C09D 5/36; C09D 7/61; C09D 7/65; C09D 7/40; C09D 175/04

(52) U.S. Cl. CPC B05D 5/061; B05D 7/572; B05D 1/36; C09D 175/04; C09D 7/61; C09D 7/65; C09D 7/70; C09D 5/36

(57) ABSTRACT

A method for forming a multilayer coating film, comprising: (1) applying a yellow pigment-containing paint (X) to a substrate to form at least one layer of a yellow coating film; (2) applying an effect pigment dispersion (Y) to the yellow coating film to form an effect coating film; (3) applying a clear paint (Z) to the effect coating film to form a clear coating film; and (4) heating the yellow coating film, the effect coating film, and the clear coating film to separately or simultaneously cure the coating films, wherein the multilayer coating film has an h value of 60 to 120°, the multilayer coating film has a Y5 value of 200 or more, and the multilayer coating film has a CS value of 90 or more, wherein the CS value is expressed by a specific equation.

### TECHNICAL FIELD

The present invention relates to a method for forming a multilayer coating film.

### BACKGROUND ART

The purpose of applying paints is mainly to protect materials, and impart an excellent appearance. For industrial products, excellent appearance, particularly “color and texture,” is important in terms of enhancing their product power. Although there are various textures for industrial products desired by consumers, a vivid, bright yellow color with pearl-like luster (hereinafter referred to as “yellow pearlescence”) has recently been desired in the field of automobile exterior panels, automobile components, home appliances, and the like.

Patent Literature 1 discloses a method for forming a mica coating film with a sophisticated design, comprising forming a color base coating film on a substrate on which an undercoating film and an intermediate coating film are formed beforehand, bake-curing the coating film, and sequentially forming a base color coating film, a mica base coating film, and a clear coating film; wherein the hue of the color base coating film, the hue of the base color coating film, and the hue of the mica base coating film are similar colors, and a mica base paint for forming the mica base coating film contains a transparent pigment and a non-transparent pigment at a weight ratio of 3/1 to 20/1.

Patent Literature 2 discloses a method for forming an effect multilayer coating film having a reddish to yellowish hue on a substrate, the method comprising applying a color base paint to the substrate to form a color base coating film, applying an effect paint to the color base coating film to form an effect coating film, and applying a top clear paint to the effect coating film to form a top clear coating film; wherein the interference color in a highlight portion of the effect coating film and the color of the color base coating film are similar colors in the range of 10RP to 10Y in the Munsell hue.

Patent Literature 3 discloses a method for forming a golden coating film, the method comprising a base coating film formation step of applying a base paint containing a titanic acid flake pigment to an intermediate coating film or a colored base coating film to form a base coating film; a clear coating film formation step of forming a clear coating film on the base coating film; and a yellowing step of applying hydrogen peroxide to the uppermost coating film to yellow the titanic acid pigment.

### CITATION LIST

### Patent Literature

PTL 1: JP2003-236465A
PTL 2: JP2006-289247A
PTL 3: JP2006-263568A

### SUMMARY OF INVENTION

### Technical Problem

The coating films obtained in Patent Literature 1 to 3 are poor in vividness and brightness, even if they are yellow coating films.

An object of the present invention is to provide a method for forming a multilayer coating film that enables the formation of a vivid, bright yellow-pearlescent coating film.

### Solution to Problem

To achieve the above object, the present invention includes the subject matter described in the following items.

Item 1. A method for forming a multilayer coating film, comprising:

(1) applying a yellow pigment-containing paint (X) to a substrate to form at least one layer of a yellow coating film;

(2) applying an effect pigment dispersion (Y) to the yellow coating film to form an effect coating film;

(3) applying a clear paint (Z) to the effect coating film to form a clear coating film; and

(4) heating the yellow coating film, the effect coating film, and the clear coating film to separately or simultaneously cure the coating films,

wherein the yellow pigment contained in the yellow coating film has an optical density of 750 to 7000, wherein the optical density is a value obtained by multiplying the pigment concentration by the film thickness,

the effect pigment dispersion (Y) contains water, a rheology control agent (A), and an interference flake-effect pigment (B),

the multilayer coating film has an h value of 60 to 120°,

the multilayer coating film has a Y5 value of 200 or more, and

the multilayer coating film has a CS value of 90 or more, wherein the CS value is expressed by Equation 1:

CS=[(L*110)²+(C*110)²]^{1/2} (Equation 1).

Item 2. The method for forming a multilayer coating film according to Item 1, wherein the measurement value of graininess (HG value) is 60 or less.
Item 3. The method for forming a multilayer coating film according to Item 1 or 2, wherein the yellow pigment contains bismuth vanadate.
Item 4. The method for forming a multilayer coating film according to any one of Items 1 to 3, wherein the rheology control agent (A) is a cellulose nanofiber.
Item 5. The method for forming a multilayer coating film according to any one of Items 1 to 4, wherein the interference flake-effect pigment (B) is one or more pigments whose interference color is selected from an achromatic color, gold, and green.
Item 6. The method for forming a multilayer coating film according to any one of Items 1 to 5, wherein the clear paint (Z) is a two-component clear paint containing a hydroxy-containing resin and a polyisocyanate compound.
Item 7. A multilayer coating film to be formed on a substrate, comprising:

at least one layer of a yellow coating film containing a yellow pigment;

an effect coating film formed on the yellow coating film; and

a clear coating film formed on the effect coating film,

wherein the yellow pigment contained in the yellow coating film has an optical density of 750 to 7000, wherein the optical density is a value obtained by multiplying the pigment concentration by the film thickness,

the effect coating film contains a rheology control agent (A) and an interference flake-effect pigment (B),

the multilayer coating film has an h value of 60 to 120,

the multilayer coating film has a Y5 value of 200 or more, and

the multilayer coating film has a CS value of 90 or more, wherein the CS value is expressed by Equation 1:

CS=[(L*110)²+(C*110)²]^{1/2} (Equation 1).

Item 8. The multilayer coating film according to Item 7, wherein the measurement value of graininess (HG value) is 60 or less.
Item 9. The multilayer coating film according to Item 7 or 8, wherein the yellow pigment contains bismuth vanadate.
Item 10. The multilayer coating film according to any one of Items 7 to 9, wherein the rheology control agent (A) is a cellulose nanofiber.
Item 11. The multilayer coating film according to any one of Items 7 to 10, wherein the interference flake-effect pigment (B) is one or more pigments whose interference color is selected from an achromatic color, gold, and green.
Item 12. The multilayer coating film according to any one of Items 7 to 11, wherein the clear coating film is obtained by applying a two-component clear paint containing a hydroxy-containing resin and a polyisocyanate compound.

### Advantageous Effects of Invention

According to the method for forming a multilayer coating film of the present invention, a vivid, bright yellow-pearlescent coating film is obtained.

### DESCRIPTION OF EMBODIMENTS

The method for forming a multilayer coating film of the present invention is described below in detail.

### 1. Step (1)

Step (1) is to apply a yellow pigment-containing paint (hereinafter also referred to as “the yellow paint”) (X) to a substrate to form at least one layer of a yellow coating film.

In the present specification, the yellow pigment refers to a pigment in which the hue angle h in the L*C*h color space diagram is within the range of 68° to 112°.

The yellow coating film may be a single layer, or two or more layers formed by applying the yellow paint (X) two or more times. When the yellow paint (X) is applied two or more times, the individual yellow paints (X) may be the same or different, and a non-yellow coating film may be sandwiched between the layers of the yellow coating film. The non-yellow coating film may be, for example, a transparent coating film or a white coating film. The transparent coating film can be obtained by, for example, applying a base paint or a clear paint; and the white coating film can be obtained by, for example, applying a white intermediate paint and/or a white base paint.

The yellow pigment contained in the yellow coating film has an optical density of 750 to 7000, preferably 840 to 4500, and more preferably 2500 to 3500.

The optical density as used herein is a value obtained by multiplying the pigment concentration (parts by mass) by the film thickness (μm) of the coating film. The pigment concentration is expressed in parts by mass of the pigment based on 100 parts by mass of the total resin solids content in the paint.

An optical density of less than 750 is not preferable in terms of yellow pearlescence, because yellow color is not exhibited sufficiently. An optical density of more than 7000 increases the thickness of the yellow coating film, resulting in impaired general performance of the coating film, such as uneven coating and peeling.

When the yellow coating film is formed of two or more layers, the optical densities of the yellow pigments in the layers of the yellow coating film are summed. In this case, the thickness of a non-yellow coating film sandwiched between the two or more layers of the yellow coating film is not included.

### Substrate

The substrate to which the method of the present invention can be applied is not particularly limited. Examples include exterior panels of vehicle bodies, such as automobiles, trucks, motorcycles, and buses; automobile components; and exterior panels of home appliances, such as mobile phones and audio equipment. Among these, vehicle body exterior panels and automobile components are preferable.

The base materials that form these substrates are not particularly limited. Examples include metal plates, such as iron plates, aluminum plates, brass plates, copper plates, stainless steel plates, tin plates, galvanized steel plates, and alloyed zinc (Zn—Al, Zn—Ni, Zn—Fe or the like)-plated steel plates; resins, such as polyethylene resin, polypropylene resin, acrylonitrile-butadiene-styrene (ABS) resin, polyamide resin, acrylic resin, vinylidene chloride resin, polycarbonate resin, polyurethane resin, and epoxy resin; plastic materials, such as various FRPs; inorganic materials, such as glass, cement, and concrete; wood; fibrous materials, such as paper and cloth; and the like. Among these, metal plates or plastic materials are preferable. Further, these materials can be subjected to degreasing treatment or surface treatment, if necessary, to thereby form base materials.

Moreover, the above substrate may be one in which an undercoating film and/or an intermediate coating film is formed on a base material mentioned above. When the base material is made of metal, chemical conversion treatment using phosphate, chromate, or the like is preferably performed before an undercoating film is formed.

The undercoating film is formed for the purpose of imparting, for example, anticorrosion, antirust, and adhesion to the base material; and masking properties for the unevenness of the base material surface. As undercoating paints for forming such undercoating films, those that are themselves known can be used. For example, cationic or anionic electrodeposition paints are preferably applied to conductive base materials, such as metals. Chlorinated polyolefin resin-based paints are preferably applied to low-polarity base materials, such as polypropylene.

After the application, the undercoating paint may be cured by heating, blowing, or like means; or may be dried to an extent that does not cause curing. When a cationic or anionic electrodeposition paint is used as the undercoating paint, the undercoating film is preferably cured by heating after applying the undercoating paint so as to prevent the formation of a mixed layer between the undercoating film and a coating film sequentially formed on the undercoating film, and to form a multilayer coating film of excellent appearance. The above base material surface and undercoating film are also called “undercoating.”

The intermediate coating film is formed to conceal the undercoating, to improve the adhesion between the undercoating and the top coating film, and to impart chipping resistance to the coating film. The intermediate coating film can be formed by applying an intermediate paint to the undercoating surface, followed by curing. The number of intermediate coating films may be one or two or more, and each layer may be cured or uncured.

The intermediate paint is not particularly limited, and known intermediate paints can be used. It is preferable to use, for example, organic-solvent-based or aqueous-based intermediate paints comprising a thermosetting resin composition and a coloring pigment.

In terms of obtaining a vivid, bright yellow-pearlescent coating film, the intermediate coating film is preferably a white intermediate coating film.

In the method of the present invention, when a member in which an undercoating film and/or an intermediate coating film is formed is used as a base material, a paint of the subsequent step can be applied after the undercoating film and/or the intermediate coating film is cured beforehand by heating. However, in some cases, a paint of the subsequent step can be applied while the undercoating film and/or the intermediate coating film is in an uncured state.

When the material of the substrate is plastic, a primer coating film is preferably formed on a degreased plastic material using a primer paint.

The yellow coating film can be obtained by applying the yellow pigment-containing paint (X).

### Yellow Pigment-Containing Paint (X)

Examples of the yellow pigment contained in the yellow pigment-containing paint (X) include bismuth vanadate, chrome yellow, monoazo pigments, disazo pigments, benzimidazolone pigments, isoindolinone pigments, isoindoline pigments, quinophthalone pigments, azomethine pigments, anthrone pigments, and the like. Of these, it is preferable to use bismuth vanadate, in terms of obtaining a vivid, bright yellow-pearlescent coating film.

The yellow pigment-containing paint may be an intermediate paint, a base paint, or a clear paint.

### Yellow Pigment-Containing Intermediate Paint

The yellow pigment-containing intermediate paint (hereinafter also referred to as “the yellow intermediate paint”) is used to ensure surface smoothness of the coating film; and to strengthen coating film properties, such as impact resistance and chipping resistance. The “chipping resistance” mentioned herein is tolerance to damage to coating films caused by the collision of obstructions, such as small stones.

The yellow intermediate paint used in this step is a thermosetting paint that is commonly used in this field, and that contains a yellow pigment mentioned above as an essential component. The yellow pigment content in the yellow intermediate paint is preferably within the range of 1 to 500 parts by mass, more preferably 3 to 400 parts by mass, and even more preferably 5 to 300 parts by mass, based on 100 parts by mass of the total resin solids content in the yellow intermediate paint, in terms of obtaining a vivid, bright yellow-pearlescent coating film.

The yellow intermediate paint preferably contains a base resin, a curing agent, and a medium comprising water and/or an organic solvent.

As the base resin and the curing agent, known compounds commonly used in this field can be used. Examples of the base resin include acrylic resins, polyester resins, epoxy resins, polyurethane resins, and the like. Examples of the curing agent include amino resins, polyisocyanate compounds, blocked polyisocyanate compounds, and the like.

In addition to the yellow pigment, the base resin, and the curing agent, the yellow intermediate paint used in the method of the present invention may suitably contain an ultraviolet absorber, an antifoaming agent, a thickener, a rust inhibitor, a surface adjusting agent, a pigment other than the yellow pigment, or the like, if necessary.

Examples of pigments other than the yellow pigment include color pigments other than the yellow pigment, extender pigments, effect pigments, and the like. These pigments can be used singly, or in a combination of two or more.

Examples of the color pigments other than the yellow pigment include titanium oxide, iron oxide, zinc white, carbon black, molybdenum red, Prussian blue, cobalt blue, azo pigments, phthalocyanine pigments, quinacridone pigments, isoindoline pigments, threne pigments, perylene pigments, dioxazine pigments, diketopyrrolopyrrole pigments, and the like. Of these, titanium oxide can be preferably used.

Examples of the extender pigments include clay, kaolin, barium sulfate, barium carbonate, calcium carbonate, talc, silica, alumina white, and the like. Of these, barium sulfate and/or talc is preferably used. In particular, it is preferable to use barium sulfate with an average primary particle size of 1 μm or less, and more preferably 0.01 to 0.8 μm, as the extender pigment, in terms of obtaining a multilayer coating film having appearance with excellent smoothness.

In the present specification, the average primary particle size of barium sulfate is determined by observing barium sulfate using a scanning electron microscope, and averaging the maximum diameter of 20 barium sulfate particles on a straight line drawn at random on the electron microscope photograph.

Examples of the effect pigments include aluminum (including vapor-deposited aluminum), copper, zinc, brass, nickel, aluminum oxide, mica, titanium oxide- or iron oxide-coated aluminum oxide, titanium oxide- or iron oxide-coated mica, glass flakes, silica flakes, holographic pigments, and the like. These effect pigments can be used singly, or in a combination of two or more. Examples of aluminum pigments include non-leafing aluminum pigments and leafing aluminum pigments. Any of these pigments can be used. The total content of the pigment(s) including the yellow pigment in the yellow intermediate paint is preferably within the range of 1 to 500 parts by mass, more preferably 3 to 400 parts by mass, and even more preferably 5 to 300 parts by mass, based on 100 parts by mass of the total resin solids content in the yellow intermediate paint.

In particular, when the yellow intermediate paint contains a color pigment other than the yellow pigment and/or an extender pigment, the total content of the color pigment and the extender pigment is preferably within the range of 1 to 500 parts by mass, more preferably 3 to 400 parts by mass, and even more preferably 5 to 300 parts by mass, based on 100 parts by mass of the total resin solids content in the yellow intermediate paint.

When the yellow intermediate paint contains a color pigment other than the yellow pigment, the content of the color pigment is preferably within the range of 1 to 300 parts by mass, more preferably 3 to 250 parts by mass, and even more preferably 5 to 200 parts by mass, based on 100 parts by mass of the total resin solids content in the yellow intermediate paint.

When the yellow intermediate paint contains an extender pigment, the content of the extender pigment is preferably within the range of 1 to 300 parts by mass, more preferably 5 to 250 parts by mass, and even more preferably 10 to 200 parts by mass, based on 100 parts by mass of the total resin solids content in the yellow intermediate paint.

When the yellow intermediate paint contains an effect pigment, the content of the effect pigment is preferably within the range of 0.1 to 50 parts by mass, more preferably 0.2 to 30 parts by mass, and even more preferably 0.3 to 20 parts by mass, based on 100 parts by mass of the total resin solids content in the yellow intermediate paint.

Coating of the yellow intermediate paint having the above structure improves the surface smoothness, impact resistance, and chipping resistance of the substrate.

As the coating method for the yellow intermediate paint, general coating methods commonly used in this field can be used. Examples of the coating method include coating methods using a brush or a coater. Among these, a coating method using a coater is preferable. Preferable examples of the coater include an airless spray coater, an air spray coater, and a rotary-atomization electrostatic coater, such as a paint cassette coater; a rotary-atomization electrostatic coater is particularly preferable.

The yellow coating film formed in this step is a coating film obtained by applying the yellow intermediate paint, followed by preheating or heating for drying or curing, in terms of preventing the formation of a mixed layer between the yellow coating film and an effect coating film formed in step (2) described later. Insufficient drying or heating of the yellow intermediate paint impairs pearlescence of the resulting multilayer coating film.

The preheating temperature is preferably within the range of 50 to 100° C., and particularly preferably 70 to 80° C. The preheating time is preferably within the range of 1 to 5 minutes, and particularly preferably 2 to 3 minutes.

When the yellow intermediate paint is heated, the heating temperature is preferably within the range of 80 to 180° C., and particularly preferably 120 to 160° C. The heat treatment time is preferably within the range of 10 to 60 minutes, and particularly preferably 15 to 40 minutes.

The cured film thickness of the yellow coating film is preferably within the range of 5 to 50 μm, and particularly preferably 10 to 40 μm, in terms of obtaining a vivid, bright yellow-pearlescent coating film in the resulting multilayer coating film.

The yellow intermediate paint may be applied in two or more layers. When two layers of the yellow intermediate paint are applied, the cured film thickness of the yellow coating film is preferably within the range of 10 to 100 μm, and particularly preferably 20 to 80 μm in total for the two layers.

### Yellow Pigment-Containing Base Paint

The yellow pigment-containing base paint (hereinafter also referred to as “the yellow base paint”) may be a known paint composition. The yellow base paint for use is particularly preferably a paint composition typically used in, for example, coating vehicle bodies.

The yellow base paint contains a yellow pigment mentioned above as an essential component. The yellow pigment content in the yellow base paint is preferably within the range of 0.01 to 50 parts by mass, and more preferably 0.1 to 30 parts by mass, based on 100 parts by mass of the total resin solids content in the yellow base paint, in terms of obtaining a vivid, bright yellow-pearlescent coating film.

The yellow base paint is preferably a paint containing a base resin, a curing agent, and a medium comprising water and/or an organic solvent. As the base resin and the curing agent, known compounds commonly used in this field can be used.

The base resin is preferably a resin excellent in weather resistance and transparency. Specific examples include acrylic resins, polyester resins, epoxy resins, urethane resins, and the like.

Examples of acrylic resins include resins obtained by copolymerizing monomer components, such as α,β-ethylenically unsaturated carboxylic acids, (meth)acrylic acid esters having a functional group, such as a hydroxyl group, an amide group, or a methylol group, other (meth)acrylic-acid esters, and styrene.

Examples of polyester resins include those obtained by the condensation reaction of polybasic acid, polyhydric alcohol, or denatured oil by a conventional method.

Examples of epoxy resins include an epoxy resin obtained by a method in which an epoxy ester is synthesized by the reaction of an epoxy group and an unsaturated fatty acid, and an α,β-unsaturated acid is added to this unsaturated group; an epoxy resin obtained by a method in which the hydroxyl group of epoxy ester and a polybasic acid, such as phthalic acid or trimellitic acid, are esterified; and the like.

Examples of urethane resins include urethane resins obtained by reacting at least one diisocyanate compound selected from the group consisting of an aliphatic diisocyanate compound, an alicyclic diisocyanate compound, and an aromatic diisocyanate compound, with at least one polyol compound selected from the group consisting of polyether polyol, polyester polyol, and polycarbonate polyol; urethane resins whose molecular weight is increased by reacting an acrylic resin, a polyester resin, or an epoxy resin mentioned above with a dipolyisocyanate compound; and the like.

The yellow base paint may be an aqueous paint or a solvent-based paint. From the standpoint of reducing the VOC of the paint, the yellow base paint is preferably an aqueous paint. When the yellow base paint is an aqueous paint, the base resin can be made soluble in water or dispersed in water by using a resin containing a hydrophilic group, such as a carboxyl group, a hydroxyl group, a methylol group, an amino group, a sulfonic acid group, or a polyoxyethylene group, most preferably a carboxyl group, in an amount sufficient for making the resin soluble in water or dispersed in water; and neutralizing the hydrophilic group. The amount of the hydrophilic group (e.g., a carboxyl group) is not particularly limited, and can be suitably selected depending on the degree of water solubilization or water dispersion. The amount of the hydrophilic group is generally such that the acid value is about 10 mgKOH/g or more, and preferably 30 to 200 mgKOH/g. Examples of the alkaline substance used in neutralization include sodium hydroxide, amine compounds, and the like.

Moreover, dispersion of the above resin in water can be performed by emulsion polymerization of the monomer components in the presence of a surfactant, and optionally a water-soluble resin. Furthermore, the water dispersion can also be obtained by, for example, dispersing the above resin in water in the presence of an emulsifier. In the water dispersion, the base resin may not contain the above hydrophilic group at all, or may contain the above hydrophilic group in an amount that is less than that of the water-soluble resin.

The curing agent is used to crosslink and cure the base resin by heating. Examples include amino resins, polyisocyanate compounds (including unblocked polyisocyanate compounds and blocked polyisocyanate compounds), epoxy-containing compounds, carboxy-containing compounds, carbodiimide group-containing compounds, hydrazide group-containing compounds, semicarbazide group-containing compounds, and the like. Preferable among these are amino resins reactive with a hydroxyl group, polyisocyanate compounds, and carbodiimide group-containing compounds reactive with a carboxyl group. These curing agents can be used singly, or in a combination of two or more.

Specifically, amino resins obtained by condensation or co-condensation of formaldehyde with melamine, benzoguanamine, urea, or the like; or further etherification with a lower monohydric alcohol, are suitably used. Further, a polyisocyanate compound can also be suitably used.

The ratio of each component in the yellow base paint may be freely selected, as required. In terms of water resistance, appearance, and the like, it is generally preferable that the ratio of the base resin is 50 to 90 mass %, and particularly 60 to 85 mass %, based on the total mass of the base resin and the curing agent; and that the ratio of the curing agent is 10 to 50 mass %, and particularly 15 to 40 mass %, based on the total mass of the base resin and the curing agent.

An organic solvent can also be used for the yellow base paint, if necessary. Specifically, organic solvents generally used for paints can be used. Examples of organic solvents include hydrocarbons, such as toluene, xylene, hexane, and heptane; esters, such as ethyl acetate, butyl acetate, ethylene glycol monomethyl ether acetate, diethylene glycol monoethyl ether acetate, and diethylene glycol monobutyl acetate; ethers, such as ethylene glycol monomethyl ether, ethylene glycol diethyl ether, diethylene glycol monomethyl ether, and diethylene glycol dibutyl ether; alcohols, such as butanol, propanol, octanol, cyclohexanol, and diethylene glycol; ketones, such as methyl ethyl ketone, methyl isobutyl ketone, cyclohexanone, and isophorone; and other organic solvents. These can be used singly, or in a combination of two or more.

In addition to the above components, the yellow base paint may suitably contain a color pigment other than the yellow pigment, an extender pigment, an ultraviolet absorber, an antifoaming agent, a rheology control agent, a rust inhibitor, a surface adjusting agent, or the like, if necessary.

When the yellow base paint contains a color pigment other than the yellow pigment, the yellow base paint can contain titanium oxide, in terms of control of light transmittance; and can further contain conventionally known color pigments other than titanium oxide, if necessary. The color pigment is not particularly limited. Specific examples include composite metal oxide pigments, such as carbon black and iron oxide pigments; azo pigments, quinacridone pigments, diketopyrrolopyrrole pigments, perylene pigments, perinone pigments, benzimidazolone pigments, isoindoline pigments, isoindolinone pigments, metal chelate azo pigments, phthalocyanine pigments, indanthrone pigments, dioxane pigments, threne pigments, indigo pigments, effect pigments, and the like. Any of these pigments can be used singly, or in a combination of two or more. Examples of effect pigments include those mentioned in the section regarding the yellow intermediate paint.

When the yellow base paint contains a color pigment other than the yellow pigment, the amount thereof is preferably within the range of 0.01 to 50 parts by mass, and more preferably 0.1 to 30 parts by mass, based on 100 parts by mass of the resin solids content in the yellow base paint.

When the yellow base paint contains an extender pigment, the amount thereof is preferably within the range of 0.1 to 30 parts by mass, and more preferably 0.1 to 20 parts by mass, based on 100 parts by mass of the resin solids content in the yellow base paint.

The cured film thickness of the base coating film obtained from the yellow base paint is preferably 3 μm or more, more preferably 3 to 25 μm, and even more preferably 5 to 20 μm, in terms of smoothness, pearl luster, and the like.

Coating of the yellow base paint can be performed by a general method. For example, air spray coating, airless spray coating, rotary atomization coating, and like methods can be used. An electrostatic charge may be applied, if necessary, during coating of the yellow base paint. In particular, rotary atomization electrostatic coating and air spray electrostatic coating are preferable, and rotary atomization electrostatic coating is particularly preferable.

When air spray coating, airless spray coating, or rotary atomization coating is performed, the yellow base paint is preferably adjusted to have a solids content and viscosity suitable for coating by suitably adding water and/or an organic solvent; and optionally additives, such as rheology control agents and antifoaming agents.

The solids content of the yellow base paint is preferably within the range of 10 to 60 mass %, more preferably 15 to 55 mass %, and even more preferably 20 to 50 mass %. The viscosity of the yellow base paint at 20° C. at 6 rpm measured by a Brookfield-type viscometer is preferably within the range of 200 to 7000 cps, more preferably 300 to 6000 cps, and even more preferably 500 to 5000 cps.

### Yellow Pigment-Containing Clear Paint

The yellow pigment-containing clear paint (hereinafter also referred to as “the yellow clear paint”) is a yellow and transparent paint. A coating film obtained by applying the yellow pigment-containing clear paint is colored yellow, and does not conceal the undercoat layer.

In the present specification, yellow transparency is defined by the haze value of the coating film. The yellow clear paint used in the present invention is such that the haze value of a dry film with a film thickness of 35 μm obtained by applying the yellow clear paint is 25% or less. In the present invention, the haze value is defined as a value calculated using the following Equation (2) based on the diffuse light transmittance (DF) and parallel light transmittance (PT) of a coating film formed and cured on a smooth PTFE plate, and peeled off from the plate. The DF and PT of the coating film are measured using a COH-300A turbidimeter (trade name, produced by Nippon Denshoku Industries Co., Ltd.).

Haze value=100*DF/(DF+PT) (Equation 2)

The yellow clear paint contains a yellow pigment mentioned above as an essential component. The yellow pigment content in the yellow clear paint is preferably within the range of 0.01 to 50 parts by mass, and more preferably 0.1 to 30 parts by mass, based on 100 parts by mass of the total resin solids content in the yellow clear paint, in terms of obtaining a vivid, bright yellow-pearlescent coating film.

The yellow clear paint may contain a resin component, in addition to the yellow pigment. The resin component can be the same as that usable in the yellow base paint described above. The resin component is used after being dissolved or dispersed in a solvent, such as an organic solvent and/or water.

The yellow clear paint may further contain a color pigment other than the yellow pigment, a dye, an effect pigment, and an extender pigment.

The color pigment other than the yellow pigment is preferably a transparent color pigment. In the present specification, the transparent color pigment refers to a pigment that has an average primary particle size of 200 nm or less, and that can form a coating film having a light transmittance of 50% or more in the visible light region (a wavelength of 400 nm to 700 nm) measured using an MPS-2450 spectrophotometer (trade name, produced by Shimadzu Corporation). The coating film is obtained by applying a paint comprising 20 parts by mass of the transparent color pigment based on 100 parts by mass of the resin solids content in the paint, to a smooth PTFE plate to a cured coating film thickness of 30 μm; followed by curing and peeling from the PTFE plate.

Specific examples of transparent color pigments other than the yellow pigment include composite metal oxide pigments, such as titan yellow; azo pigments, quinacridone pigments, diketopyrrolopyrrole pigments, perylene pigments, perinone pigments, benzimidazolone pigments, isoindoline pigments, isoindolinone pigments, metal chelate azo pigments, phthalocyanine pigments, indanthrone pigments, dioxane pigments, indigo pigments, and the like. Any of these pigments can be used singly, or in a combination of two or more.

When the yellow clear paint contains a color pigment other than the yellow pigment, the amount thereof is preferably within the range of 0.01 to 50 parts by mass, and more preferably 0.1 to 30 parts by mass, based on 100 parts by mass of the resin solids content in the yellow clear paint.

As the dye, specifically, any of azo dyes, triphenylmethane dyes, and the like can be used singly, or in a combination of two or more.

Examples of the effect pigment include metal flake pigments, such as aluminum flake pigments and colored aluminum flake pigments; vapor deposition metal flake pigments; interference pigments; and the like. Specific examples of the interference pigment include metal oxide-coated mica pigments, metal oxide-coated alumina flake pigments, metal oxide-coated glass flake pigments, metal oxide-coated silica flake pigments, and the like.

When the yellow clear paint contains an effect pigment, the content thereof is preferably within the range of 0.01 to 15 parts by mass, more preferably 0.1 to 10 parts by mass, and particularly preferably 0.5 to 5 parts by mass, based on 100 parts by mass of the resin solids content, in terms of the brilliance and chroma of the multilayer coating film.

Examples of the extender pigment include barium sulfate, barium carbonate, calcium carbonate, aluminum silicate, silica, magnesium carbonate, talc, alumina white, and the like.

When the yellow clear paint contains an extender pigment, the amount thereof is preferably within the range of 0.1 to 30 parts by mass, and more preferably 0.1 to 20 parts by mass, based on 100 parts by mass of the resin solids content in the yellow clear paint.

Further, the yellow clear paint may suitably contain a solvent such as water or an organic solvent, a rheology control agent, a pigment dispersant, an antisettling agent, a curing catalyst, an antifoaming agent, an antioxidant, an ultraviolet absorber, and various other additives, if necessary.

The yellow clear paint is prepared by mixing and dispersing the above components.

The solids content of the yellow clear paint during coating is preferably adjusted to 1 to 50 mass %, and more preferably 2 to 40 mass %. Further, the viscosity thereof at a temperature of 20° C. at a rotor rotational speed of 6 rpm measured by a Brookfield-type viscometer is preferably adjusted within the range of 50 to 5000 mPa·s.

The yellow clear coating film can be formed by applying the yellow clear paint by a method such as electrostatic coating, air spray coating, or airless spray coating, followed by drying and curing. The film thickness of the yellow clear coating film when cured is preferably within the range of 1 to 50 μm in terms of color expression and the smoothness of the coating film, and more preferably 2 to 40 μm.

Examples of the film structure of the yellow coating film are described below. However, the film structure is not limited to these examples. The “transparent base coating film” described below can be obtained from a base paint prepared using a composition excluding, from the yellow pigment-containing base paint described above, the yellow pigment. The “clear coating film” described below can be obtained from a clear paint prepared using a composition excluding, from the yellow pigment-containing clear paint described above, the yellow pigment.

yellow intermediate coating film

yellow intermediate coating film/transparent base coating film

yellow base coating film/transparent base coating film

yellow intermediate coating film/yellow intermediate coating film

yellow intermediate coating film/yellow intermediate coating film/transparent base coating film

yellow intermediate coating film/yellow base coating film

yellow base coating film/clear coating film/yellow base coating film

yellow intermediate coating film/yellow base coating film/clear coating film/yellow base coating film

yellow base coating film/yellow clear coating film/yellow base coating film

yellow intermediate coating film/yellow base coating film/yellow clear coating film/yellow base coating film

### 2. Step (2)

Step (2) is to apply an effect pigment dispersion (Y) to the yellow coating film formed in step (1) to form an effect coating film.

### Effect Pigment Dispersion (Y)

The effect pigment dispersion (Y) contains water, a rheology control agent (A), and an interference flake-effect pigment (B).

### Rheology Control Agent (A)

As the rheology control agent (A), a known rheology control agent can be used. Examples include silica-based fine powder, mineral-based rheology control agents, barium sulfate atomization powder, polyamide-based rheology control agents, organic resin fine particle rheology control agents, diurea-based rheology control agents, urethane association-type rheology control agents, polyacrylic acid-based rheology control agents, which are acrylic swelling-type, cellulose-based rheology control agents, and the like. Of these, particularly in terms of obtaining a coating film with excellent pearl luster, it is preferable to use a mineral-based rheology control agent, a polyacrylic acid-based rheology control agent, or a cellulose-based rheology control agent; and it is particularly preferable to use a cellulose-based rheology control agent. These rheology control agents can be used singly, or in a combination of two or more.

Examples of mineral-based rheology control agents include swelling laminar silicate that has a 2:1 type crystal structure. Specific examples include smectite group clay minerals, such as natural or synthetic montmorillonite, saponite, hectorite, stevensite, beidellite, nontronite, bentonite, and laponite; swelling mica group clay minerals, such as Na-type tetrasilicic fluorine mica, Li-type tetrasilicic fluorine mica, Na salt-type fluorine taeniolite, and Li-type fluorine taeniolite; vermiculite; substitution products or derivatives thereof; and mixtures thereof.

Examples of polyacrylic acid-based rheology control agents include sodium polyacrylate, polyacrylic acid-(meth)acrylic acid ester copolymers, and the like.

Examples of commercial products of the polyacrylic acid-based rheology control agent include “Primal ASE-60,” “Primal TT615,” and “Primal RM5” (trade names, produced by The Dow Chemical Company); “SN Thickener 613,” “SN Thickener 618,” “SN Thickener 630,” “SN Thickener 634,” and “SN Thickener 636” (trade names, produced by San Nopco Limited); and the like. The acid value of the solids content of the polyacrylic acid-based rheology control agent is within the range of 30 to 300 mgKOH/g, and preferably 80 to 280 mgKOH/g.

Examples of cellulose-based rheology control agents include carboxymethylcellulose, methylcellulose, hydroxyethylcellulose, hydroxyethylmethylcellulose, hydroxypropylmethylcellulose, methylcellulose, cellulose nanofibers, and the like. Of these, cellulose nanofibers are particularly preferably used, in terms of obtaining a coating film with excellent pearl luster.

The cellulose nanofibers may also be referred to as cellulose nanofibrils, fibrillated cellulose, or nanocellulose crystals.

The cellulose nanofibers have a number average fiber diameter within the range of preferably 2 to 500 nm, more preferably 2 to 250 nm, and even more preferably 2 to 150 nm, in terms of obtaining a coating film with excellent pearl luster. The cellulose nanofibers also have a number average fiber length within the range of preferably 0.1 to 20 μm, more preferably 0.1 to 15 μm, and even more preferably 0.1 to 10 μm. The aspect ratio determined by dividing a number average fiber length by a number average fiber diameter is within the range of preferably 50 to 10000, more preferably 50 to 5000, and even more preferably 50 to 1000.

The number average fiber diameter and number average fiber length are measured and calculated from, for example, an image obtained by subjecting a sample (cellulose nanofibers diluted with water) to a dispersion treatment, casting the sample on a grid coated with a carbon film that has been subjected to hydrophilic treatment, and observing the sample with a transmission electron microscope (TEM).

The cellulose nanofibers for use may be those obtained by defibrating a cellulose material and stabilizing it in water. The cellulose material as used here refers to cellulose-main materials in various forms. Specific examples include pulp (e.g., grass plant-derived pulp, such as wood pulp, jute, Manila hemp, and kenaf); natural cellulose, such as cellulose produced by microorganisms; regenerated cellulose obtained by dissolving cellulose in a copper ammonia solution, a solvent of a morpholine derivative, or the like, and subjecting the dissolved cellulose to spinning; fine cellulose obtained by subjecting the cellulose material to mechanical treatment, such as hydrolysis, alkali hydrolysis, enzymatic decomposition, blasting treatment, vibration ball milling, and the like, to depolymerize the cellulose; and the like.

The method for defibrating the cellulose material is not particularly limited, as long as the cellulose material remains in a fibrous form. Examples of the method include mechanical defibration treatment using a homogenizer, a grinder, and the like; chemical treatment using an oxidation catalyst and the like; and biological treatment using microorganisms and the like.

For the cellulose nanofibers, anionically modified cellulose nanofibers can be used. Examples of anionically modified cellulose nanofibers include carboxylated cellulose nanofibers, carboxymethylated cellulose nanofibers, phosphate group-containing cellulose nanofibers, and the like. The anionically modified cellulose nanofibers can be obtained, for example, by incorporating functional groups such as carboxyl groups, carboxymethyl groups, and phosphate groups into a cellulose material by a known method, washing the obtained modified cellulose to prepare a dispersion of the modified cellulose, and defibrating this dispersion. The carboxylated cellulose is also referred to as oxidized cellulose.

The oxidized cellulose is obtained, for example, by oxidizing the cellulose material in water using an oxidizing agent in the presence of a compound selected from the group consisting of N-oxyl compounds, bromide, iodide, and mixtures thereof.

The amount of an N-oxyl compound is not particularly limited, as long as the amount is a catalytic amount that can disintegrate cellulose into nanofibers. The amount of bromide or iodide can be suitably selected within the range in which an oxidation reaction is promoted.

For the oxidizing agent, a known oxidizing agent may be used. Examples include halogen, hypohalous acid, halous acid, perhalogenic acid, salts thereof, halogen oxide, peroxide, and the like. It is preferable to set the conditions so that the amount of carboxyl groups in oxidized cellulose is 0.2 mmol/g or more based on the solids content mass of the oxidized cellulose. The amount of carboxyl groups can be adjusted, for example, by performing the following: adjustment of oxidation reaction time; adjustment of oxidation reaction temperature; adjustment of pH in oxidation reaction; and adjustment of the amount of an N-oxyl compound, bromide, iodide, oxidizing agent, or the like.

The above carboxymethylated cellulose can be obtained, for example, in the following manner. The cellulose material and a solvent are mixed, and mercerization treatment is performed using 0.5 to 20-fold moles of alkali hydroxide metal per glucose residue of the cellulose material as a mercerization agent at a reaction temperature of 0 to 70° C., for a reaction time of about 15 minutes to 8 hours. Thereafter, 0.05 to 10-fold moles of a carboxymethylating agent per glucose residue is added thereto, followed by reaction at a reaction temperature of 30 to 90° C. for about 30 minutes to 10 hours.

The degree of substitution of carboxymethyl per glucose unit in the modified cellulose obtained by introducing carboxymethyl groups into the cellulose material is preferably 0.02 to 0.5.

The thus-obtained anion-modified cellulose can be dispersed in an aqueous solvent to form a dispersion, and the dispersion can be further defibrated. Although the defibration method is not particularly limited, when mechanical treatment is performed, the device to be used may be any of the following: a high-speed shearing device, a collider device, a bead mill device, a high-speed rotating device, a colloid mill device, a high-pressure device, a roll mill device, and an ultrasonic device. These devices may be used in a combination of two or more.

Examples of commercial products of cellulose nanofibers include Rheocrysta (registered trademark) produced by DKS Co. Ltd., and the like.

The cellulose-based rheology control agent in the effect pigment dispersion (Y) is preferably contained in an amount of 2 to 150 parts by mass, and particularly preferably 3 to 120 parts by mass, based on 100 parts by mass of the flake-effect pigment, in terms of obtaining a coating film with excellent pearl luster.

The content of the rheology control agent (A) in the effect pigment dispersion (Y) as a solids content is preferably 0.1 to 60 parts by mass, more preferably 0.3 to 35 parts by mass, and even more preferably 0.5 to 25 parts by mass, based on 100 parts by mass of the total solids content in the effect pigment dispersion (Y), in terms of the excellent vivid, bright yellow pearlescence of the multilayer coating film to be obtained.

### Interference Flake-Effect Pigment (B)

As the interference flake-effect pigment (B), it is preferable to use an interference pigment in which a transparent or translucent base material is coated with titanium oxide, in terms of imparting pearl luster to a multilayer coating film. In the present specification, the transparent base material refers to a base material that transmits at least 90% of visible light. The translucent base material refers to a base material that transmits at least 10% and less than 90% of visible light.

Interference pigments are effect pigments obtained by coating the surface of transparent or translucent flaky base materials, such as natural mica, synthetic mica, glass, iron oxide, aluminum oxide, and various metal oxides, with metal oxides with different refractive indices. Examples of the metal oxide include titanium oxide, iron oxide, and the like. Interference pigments can develop various different interference colors depending on the difference in the thickness of the metal oxide.

Specific examples of the interference pigment include the metal oxide-coated mica pigments, metal oxide-coated alumina flake pigments, metal oxide-coated glass flake pigments, and metal oxide-coated silica flake pigments described below.

Metal oxide-coated mica pigments are pigments obtained by coating the surface of a natural mica or synthetic mica base material with a metal oxide. Natural mica is a flaky base material obtained by pulverizing mica from ore.

Synthetic mica is synthesized by heating an industrial material, such as SiO₂, MgO, Al₂O₃, K₂SiF₆, or Na₂SiF₆, to melt the material at a high temperature of about 1500° C.; and cooling the melt for crystallization. When compared with natural mica, synthetic mica contains a smaller amount of impurities, and has a more uniform size and thickness. Specifically, known examples of synthetic mica base materials include fluorophlogopite (KMg₃AlSi₃O₁₀F₂), potassium tetrasilicon mica (KMg_{2.5}AlSi₄O₁₀F₂), sodium tetrasilicon mica (NaMg_{2.5}AlSi₄O₁₀F), Na taeniolite (NaMg₂LiSi₄O₁₀F₂), LiNa taeniolite (LiMg₂LiSi₄O₁₀F₂), and the like.

Metal oxide-coated alumina flake pigments are pigments obtained by coating the surface of an alumina flake base material with a metal oxide. Alumina flakes refer to flaky (thin) aluminum oxides, which are clear and colorless. Alumina flakes do not necessarily consist of only aluminum oxide, and may contain other metal oxides.

Metal oxide-coated glass flake pigments are pigments obtained by coating the surface of a flaky glass base material with a metal oxide. The metal oxide-coated glass flake pigments have a smooth base material surface, which causes intense light reflection.

Metal oxide-coated silica flake pigments are pigments obtained by coating flaky silica, a base material having a smooth surface and a uniform thickness, with a metal oxide.

The above interference pigments may be subjected to surface treatment in order to improve dispersibility, water resistance, chemical resistance, weather resistance, or the like.

The average particle size of the interference pigment is preferably within the range of 5 to 30 μm, and particularly preferably 7 to 20 μm, in terms of the excellent distinctness of image and pearl luster of the coating film to be obtained. The particle size as used herein refers to the median size of a volume-based particle size distribution measured by a laser diffraction scattering method using a Microtrac MT3300 particle size distribution analyzer (trade name, produced by Nikkiso Co., Ltd.).

Moreover, the thickness of the interference pigment is preferably in the range of 0.05 to 1 μm, and particularly preferably 0.1 to 0.8 μm, in terms of the excellent distinctness of image and pearl luster of the coating film to be obtained. The thickness as used herein is obtained in such a manner that when a cross-section of a coating film containing an interference pigment is observed with an optical microscope, the minor axis of the interference pigment particles is measured using image-processing software, and the average of the measured values of 100 or more particles is defined as the thickness.

The content of the interference flake-effect pigment (B) in the effect pigment dispersion (Y) is preferably 10 to 100 parts by mass, preferably 20 to 90 parts by mass, and more preferably 30 to 80 parts by mass, based on 100 parts by mass of the total solids content in the effect pigment dispersion (Y), in terms of the excellent vivid, bright yellow pearlescence of the multilayer coating film to be obtained.

### Other Components

In addition to water, the rheology control agent (A), and the interference flake-effect pigment (B), the effect pigment dispersion (Y) may further suitably contain additives, such as a surface adjusting agent (C), a crosslinkable component (D), an organic solvent, a pigment dispersant, an antisettling agent, an antifoaming agent, and a ultraviolet absorber, if necessary.

The surface adjusting agent (C) is used to facilitate uniform orientation of the above interference flake-effect pigment (B) dispersed in water on the substrate when the effect pigment dispersion (Y) is applied to the substrate.

As the surface adjusting agent (C), known surface adjusting agents can be used without limitation. In particular, in terms of the excellent distinctness of image and pearl luster of the coating film to be obtained, the surface adjusting agent (C) is preferably one having a contact angle of preferably 8 to 20°, more preferably 9 to 19°, and even more preferably 10 to 18, with respect to a previously degreased tin plate (produced by Paltek Corporation); the contact angle being measured in such a manner that a liquid that is a mixture of isopropanol, water, and the surface adjusting agent (C) at a ratio of 4.5/95/1 is adjusted to have a viscosity of 150 mPa·s measured by a Brookfield-type viscometer at a rotor rotational speed of 60 rpm at a temperature of 20° C., 10 μL of the liquid is added dropwise to the tin plate, and the contact angle with respect to the tin plate is measured 10 seconds after dropping. Specifically, the viscosity is controlled by adding Acrysol ASE-60 (trade name, a polyacrylic acid-based rheology control agent, produced by The Dow Chemical Company, solids content: 28%) and dimethylethanolamine.

The 4.5/95/1 ratio, which is the mass ratio of isopropanol/water/surface adjusting agent (C), corresponds to the component ratio of the effect pigment dispersion (Y) for evaluating the surface adjusting agent. The 150 mPa·s viscosity measured by a Brookfield-type viscometer at a rotor rotational speed of 60 rpm is a normal value during coating to a substrate. Moreover, the 8 to 20° contact angle with respect to the tin plate represents the wet spreading of liquid under standard coating conditions. When the contact angle is 8° or more, the liquid is applied to a substrate without being overly spread; whereas when the contact angle is 20° or less, the liquid is uniformly applied to a substrate without being overly repelled.

Examples of the surface adjusting agent (C) include silicone-based surface adjusting agents, acrylic-based surface adjusting agents, vinyl-based surface adjusting agents, fluorine-based surface adjusting agents, acetylenediol-based surface adjusting agents, and like surface adjusting agents. These surface adjusting agents can be used singly, or in a combination of two or more.

Examples of commercial products of the surface adjusting agent (C) include BYK series (produced by BYK-Chemie), Tego series (produced by Evonik), Glanol series and Polyflow series (produced by Kyoeisha Chemical Co., Ltd.), DISPARLON series (produced by Kusumoto Chemicals, Ltd.), Surfynol series (produced by Evonik Industries), and the like.

Usable silicone-based surface adjusting agents include polydimethylsiloxane and modified silicone obtained by modifying polydimethylsiloxane. Examples of modified silicone include polyether-modified silicone, acrylic-modified silicone, polyester-modified silicone, and the like.

The dynamic surface tension of the surface adjusting agent (C) is preferably 50 to 70 mN/m more preferably 53 to 68 mN/m, and even more preferably 55 to 65 mN/m. In the present specification, the “dynamic surface tension” refers to a surface tension value measured by the maximum bubble pressure method at a frequency of 10 Hz. The dynamic surface tension was measured using a SITA measuring apparatus (SITA t60, produced by EKO Instruments).

Moreover, the static surface tension of the surface adjusting agent (C) is preferably 15 to 30 mN/m, more preferably 18 to 27 mN/m, and even more preferably 20 to 24 mN/m. In the present specification, the “static surface tension” refers to a surface tension value measured by the platinum ring method. The static surface tension was measured using a surface tensiometer (DCAT 21, produced by EKO Instruments).

Furthermore, the lamellar length of the surface adjusting agent (C) is preferably 6 to 9 mm, more preferably 6.5 to 8.5 mm, and even more preferably 7 to 8 mm.

The content of the surface adjusting agent (C) in the effect pigment dispersion (Y) as a solids content is preferably 0.01 to 20 parts by mass, more preferably 0.02 to 10 parts by mass, and even more preferably 0.05 to 5 parts by mass, based on 100 parts by mass of the effect pigment dispersion (Y), in terms of the excellent pearl luster of the multilayer coating film to be obtained.

The effect pigment dispersion (Y) may contain a base resin and/or a crosslinkable component (D), and a dispersion resin, in terms of the anti-water adhesion and/or storage stability of the coating film to be obtained.

Examples of the base resin include acrylic resins, polyester resins, alkyd resins, urethane resins, and the like.

As the dispersion resin, existing dispersion resins, such as acrylic resins, epoxy resins, polycarboxylic acid resins, and polyester resins, can be used.

When the effect pigment dispersion (Y) contains resin components, such as a base resin, a crosslinkable component (D), and a dispersion resin, the total amount thereof is 0.01 to 1000 parts by mass, preferably 0.1 to 500 parts by mass, and more preferably 1 to 300 parts by mass, based on 100 parts by mass of the flake-effect pigment.

The effect pigment dispersion (Y) may contain a crosslinkable component (D), in terms of the anti-water adhesion of the coating film to be obtained. In particular, when a clear paint (Z), described later, is a one-component clear paint and does not contain the crosslinkable component (D), it is preferable that the effect pigment dispersion (Y) contains the crosslinkable component (D).

In the present specification, the crosslinkable component (D) is selected from the group consisting of melamine, a melamine derivative, a urea resin, (meth)acrylamide, polyaziridine, polycarbodiimide, a blocked or unblocked polyisocyanate compound, (meth)acrylamide, and a copolymer of N-methylol group- or N-alkoxymethyl group-containing (meth)acrylamide. These may be used singly, or in a combination of two or more.

Examples of melamine derivatives include partially etherified or fully etherified melamine resins produced by etherifying a part or all of methylol groups in methylolated melamine with a C₁₋₈ monohydric alcohol, such as methyl alcohol, ethyl alcohol, n-propyl alcohol, i-propyl alcohol, n-butyl alcohol, i-butyl alcohol, 2-ethylbutanol, or 2-ethylhexanol.

Examples of commercially available melamine derivatives include Cymel 202, Cymel 232, Cymel 235, Cymel 238, Cymel 254, Cymel 266, Cymel 267, Cymel 272, Cymel 285, Cymel 301, Cymel 303, Cymel 325, Cymel 327, Cymel 350, Cymel 370, Cymel 701, Cymel 703, and Cymel 1141 (all produced by Nihon Cytec Industries Inc.); U-Van 20SE60, U-Van 122, and U-Van 28-60 (all produced by Mitsui Chemicals, Inc.); Super Beckamine J-820-60, Super Beckamine L-127-60, and Super Beckamine G-821-60 (all produced by DIC); and the like. The above melamine and melamine derivatives can be used singly, or in a combination of two or more.

Examples of the N-methylol group- or N-alkoxymethyl group-containing (meth)acrylamide include (meth)acrylamides, such as N-methylolacrylamide, N-methoxymethylacrylamide, N-methoxybutylacrylamide, and N-butoxymethyl(meth)acrylamide. The above (meth)acrylamide derivatives can be used singly, or in a combination of two or more.

The unblocked polyisocyanate compound is a compound having at least two isocyanate groups per molecule. Examples include aliphatic polyisocyanates, alicyclic polyisocyanates, aromatic-aliphatic polyisocyanates, aromatic polyisocyanates, derivatives of these polyisocyanates, and the like.

Examples of aliphatic polyisocyanates include aliphatic diisocyanates, such as trimethylene diisocyanate, tetramethylene diisocyanate, hexamethylene diisocyanate, pentamethylene diisocyanate, 1,2-propylene diisocyanate, 1,2-butylene diisocyanate, 2,3-butylene diisocyanate, 1,3-butylene diisocyanate, 2,4,4- or 2,2,4-trimethylhexamethylene diisocyanate, dimer acid diisocyanate, and methyl 2,6-diisocyanatohexanoate (common name: lysine diisocyanate); aliphatic triisocyanates, such as 2-isocyanatoethyl 2,6-diisocyanatohexanoate, 1,6-diisocyanato-3-isocyanatomethylhexane, 1,4,8-triisocyanatooctane, 1,6,11-triisocyanatoundecane, 1,8-diisocyanato-4-isocyanatomethyloctane, 1,3,6-triisocyanatohexane, and 2,5,7-trimethyl-1,8-diisocyanato-5-isocyanatomethyloctane; and the like.

Examples of alicyclic polyisocyanates include alicyclic diisocyanates, such as 1,3-cyclopentene diisocyanate, 1,4-cyclohexane diisocyanate, 1,3-cyclohexane diisocyanate, 3-isocyanatomethyl-3,5,5-trimethylcyclohexyl isocyanate (common name: isophorone diisocyanate), 4-methyl-1,3-cyclohexylene diisocyanate (common name: hydrogenated TDI), 2-methyl-1,3-cyclohexylene diisocyanate, 1,3- or 1,4-bis(isocyanatomethyl)cyclohexane (common name: hydrogenated xylylene diisocyanate) or mixtures thereof, methylenebis(4,1-cyclohexanediyl)diisocyanate (common name: hydrogenated MDI), and norbornane diisocyanate; alicyclic triisocyanates, such as 1,3,5-triisocyanatocyclohexane, 1,3,5-trimethylisocyanatocyclohexane, 2-(3-isocyanatopropyl)-2,5-di(isocyanatomethyl)-bicyclo(2.2.1)heptane, 2-(3-isocyanatopropyl)-2,6-di(isocyanatomethyl)-bicyclo(2.2.1)heptane, 3-(3-isocyanatopropyl)-2,5-di(isocyanatomethyl)-bicyclo(2.2.1)heptane, 5-(2-isocyanatoethyl)-2-isocyanatomethyl-3-(3-isocyanatopropyl)-bicyclo(2.2.1)heptane, 6-(2-isocyanatoethyl)-2-isocyanatomethyl-3-(3-isocyanatopropyl)-bicyclo(2.2.1)heptane, 5-(2-isocyanatoethyl)-2-isocyanatomethyl-2-(3-isocyanatopropyl)-bicyclo(2.2.1)heptane, and 6-(2-isocyanatoethyl)-2-isocyanatomethyl-2-(3-isocyanatopropyl)-bicyclo(2.2.1)heptane; and the like.

Examples of aromatic-aliphatic polyisocyanates include aromatic-aliphatic diisocyanates, such as methylenebis(4,1-phenylene)diisocyanate (common name: MDI), 1,3- or 1,4-xylylene diisocyanate or mixtures thereof, ω,ω′-diisocyanato-1,4-diethylbenzene, 1,3- or 1,4-bis(1-isocyanato-1-methylethyl)benzene (common name: tetramethylxylylene diisocyanate) or mixtures thereof; aromatic-aliphatic triisocyanates, such as 1,3,5-triisocyanatomethylbenzene; and the like.

Examples of aromatic polyisocyanates include aromatic diisocyanates, such as m-phenylene diisocyanate, p-phenylene diisocyanate, 4,4′-diphenyl diisocyanate, 1,5-naphthalene diisocyanate, 2,4-tolylene diisocyanate (common name: 2,4-TDI), or 2,6-tolylene diisocyanate (common name: 2,6-TDI) or mixtures thereof, 4,4′-toluidine diisocyanate, and 4,4′-diphenylether diisocyanate; aromatic triisocyanates, such as triphenylmethane-4,4′,4″-triisocyanate, 1,3,5-triisocyanatobenzene, and 2,4,6-triisocyanatotoluene; aromatic tetraisocyanates, such as 4,4′-diphenylmethane-2,2′,5,5′-tetraisocyanate; and the like.

Examples of polyisocyanate derivatives include dimers, trimers, biurets, allophanates, urethodiones, urethoimines, isocyanurates, oxadiazinetriones, polymethylene polyphenyl polyisocyanates (crude MDI, polymeric MDI), crude TDI, and the like, of the above-mentioned polyisocyanates. These polyisocyanate derivatives may be used singly, or in a combination of two or more. The above polyisocyanates and derivatives thereof may be used singly, or in a combination of two or more.

Among the aliphatic diisocyanates, hexamethylene diisocyanate or derivatives thereof are preferably used, and among the alicyclic diisocyanates, 4,4′-methylenebis(cyclohexyl isocyanate) is preferably used. Of these, derivatives of hexamethylene diisocyanate are particularly the most preferable, in terms of adhesion, compatibility, and the like.

As the polyisocyanate compound, it is also possible to use a prepolymer formed by reacting the polyisocyanate or a derivative thereof with a compound having active hydrogen, such as hydroxyl or amino, and reactive to the polyisocyanate under conditions such that the isocyanate groups are present in excess. Examples of the compound reactive to the polyisocyanate include polyhydric alcohols, low-molecular-weight polyester resins, amine, water, and the like. The above polyisocyanate compounds can be used singly, or in a combination of two or more.

The blocked polyisocyanate compound is a blocked polyisocyanate compound in which some or all of the isocyanate groups of the above polyisocyanate or a derivative thereof are blocked with a blocking agent.

Examples of the blocking agent include phenol-based blocking agents, lactam-based blocking agents, aliphatic alcohol-based blocking agents, ether-based blocking agents, alcohol-based blocking agents, oxime-based blocking agents, active methylene-based blocking agents, mercaptan-based blocking agents, acid amide-based blocking agents, imide-based blocking agents, amine-based blocking agents, imidazole-based blocking agents, urea-based blocking agents, carbamate-based blocking agents, imine-based blocking agents, sulfite-based blocking agents, azole-based compounds, and the like.

Examples of phenol-based blocking agents include phenol, cresol, xylenol, nitrophenol, ethylphenol, hydroxydiphenyl, butylphenol, isopropylphenol, nonylphenol, octylphenol, methyl hydroxybenzoate, and the like.

Examples of lactam-based blocking agents include ε-caprolactam, δ-valerolactam, γ-butyrolactam, β-propiolactam, and the like.

Examples of aliphatic alcohol-based blocking agents include methanol, ethanol, propyl alcohol, butyl alcohol, amyl alcohol, lauryl alcohol, and the like.

Examples of ether-based blocking agents include ethylene glycol monomethyl ether, ethylene glycol monoethyl ether, ethylene glycol monobutyl ether, diethylene glycol monomethyl ether, diethylene glycol monoethyl ether, propylene glycol monomethyl ether, methoxymethanol, and the like.

Examples of alcohol-based blocking agents include benzyl alcohol, glycolic acid, methyl glycolate, ethyl glycolate, butyl glycolate, lactic acid, methyl lactate, ethyl lactate, butyl lactate, methylol urea, methylol melamine, diacetone alcohol, 2-hydroxyethyl acrylate, 2-hydroxyethyl methacrylate, and the like.

Examples of oxime-based blocking agents include formamide oxime, acetamide oxime, acetoxime, methyl ethyl ketoxime, diacetyl monoxime, benzophenone oxime, cyclohexane oxime, and the like.

Examples of active methylene-based blocking agents include dimethyl malonate, diethyl malonate, ethyl acetoacetate, methyl acetoacetate, acetylacetone, and the like.

Examples of mercaptan-based blocking agents include butyl mercaptan, t-butyl mercaptan, hexyl mercaptan, t-dodecyl mercaptan, 2-mercaptobenzothiazole, thiophenol, methylthiophenol, ethylthiophenol, and the like.

Examples of acid amide-based blocking agents include acetanilide, acetanisidide, acetotoluide, acrylamide, methacrylamide, acetic acid amide, stearic acid amide, benzamide, and the like.

Examples of imide-based blocking agents include succinimide, phthalimide, maleimide, and the like.

Examples of amine-based blocking agents include diphenylamine, phenylnaphthylamine, xylidine, N-phenylxylidine, carbazole, aniline, naphthylamine, butylamine, dibutylamine, butylphenylamine, and the like.

Examples of imidazole-based blocking agents include imidazole, 2-ethylimidazole, and the like.

Examples of urea-based blocking agents include urea, thiourea, ethyleneurea, ethylenethiourea, diphenylurea, and the like.

Examples of carbamate-based blocking agents include phenyl N-phenylcarbamate and the like.

Examples of imine-based blocking agents include ethyleneimine, propyleneimine, and the like.

Examples of sulfite-based blocking agents include sodium bisulfite, potassium bisulfite, and the like.

Examples of azole-based compounds include pyrazole or pyrazole derivatives, such as pyrazole, 3,5-dimethylpyrazole, 3-methylpyrazole, 4-benzyl-3,5-dimethylpyrazole, 4-nitro-3,5-dimethylpyrazole, 4-bromo-3,5-dimethylpyrazole, and 3-methyl-5-phenylpyrazole; imidazole or imidazole derivatives, such as imidazole, benzimidazole, 2-methylimidazole, 2-ethylimidazole, and 2-phenylimidazole; imidazoline derivatives, such as 2-methylimidazoline and 2-phenylimidazoline.

When blocking is performed (a blocking agent is reacted), it can be performed by adding a solvent, if necessary. As the solvent used in the blocking reaction, a solvent that is not reactive with an isocyanate group is preferably used. Examples include ketones, such as acetone and methyl ethyl ketone; esters, such as ethyl acetate; N-methyl-2-pyrrolidone (NMP); and like solvents. The above blocked polyisocyanate compounds can be used singly, or in a combination of two or more.

When the effect pigment dispersion (Y) contains a crosslinkable component (D), the content of the crosslinkable component (D) as a solids content is preferably within the range of 1 to 100 parts by mass, more preferably 5 to 95 parts by mass, and even more preferably 10 to 90 parts by mass, based on 100 parts by mass of the solids content of the interference flake-effect pigment (B) in the effect pigment dispersion (Y), in terms of the anti-water adhesion of the coating film.

When the effect pigment dispersion (Y) contains a base resin and a dispersion resin described above, and further contains a crosslinkable component (D), the total amount of the base resin, the dispersion resin, and the crosslinkable component (D) is, in terms of forming a coating film with pearl luster, 0.01 to 1000 parts by mass, preferably 0.1 to 500 parts by mass, and more preferably 1 to 300 parts by mass, based on 100 parts by mass of the solids content of the interference flake-effect pigment (B) in the effect pigment dispersion (Y), in terms of the anti-water adhesion of the coating film.

The effect pigment dispersion (Y) may contain pigments other than the interference flake-effect pigment (B), such as other flake-effect pigments, color pigments, and extender pigments, if necessary.

Examples of flake-effect pigments other than the interference flake-effect pigment (B) include aluminum flake pigments, vapor deposition metal flake pigments, and the like.

The color pigment is not particularly limited. Specific examples include composite metal oxide pigments, such as titan yellow; inorganic pigments, such as transparent iron oxide pigments; organic pigments, such as azo pigments, quinacridone pigments, diketopyrrolopyrrole pigments, perylene pigments, perinone pigments, benzimidazolone pigments, isoindoline pigments, isoindolinone pigments, metal chelate azo pigments, phthalocyanine pigments, indanthrone pigments, dioxazine pigments, threne pigments, and indigo pigments; carbon black pigments; and the like. These can be used singly, or in a combination of two or more.

Examples of extender pigments include talc, silica, calcium carbonate, barium sulfate, zinc white (zinc oxide), and the like. These can be used singly, or in a combination of two or more.

The effect pigment dispersion (Y) is prepared by mixing and dispersing the above components. The solids content during coating is 0.5 to 10 mass %, and preferably 1 to 8 mass %, based on the effect pigment dispersion (Y), in terms of obtaining a coating film with low graininess and excellent pearl luster.

The viscosity of the effect pigment dispersion (Y) at a temperature of 20° C. measured by a Brookfield-type viscometer at 60 rpm after 1 minute (also referred to as “the B60 value” in the present specification) is preferably 50 to 900 mPa·s, and more preferably 100 to 800 mPa·s, in terms of obtaining a coating film with excellent pearl luster. The viscometer used in this case is a VDA-type digital Vismetron viscometer (a Brookfield-type viscometer, produced by Shibaura System Co., Ltd.).

The effect pigment dispersion (Y) can be applied by a method such as electrostatic coating, air spray coating, or airless spray coating. In the method for forming a multilayer coating film of the present invention, rotary atomization electrostatic coating is particularly preferable.

The film thickness 30 seconds after the effect pigment dispersion (Y) is attached to the substrate is preferably 3 to 100 μm, more preferably 4 to 80 μm, and even more preferably 5 to 60 μm, in terms of obtaining a coating film with excellent pearl luster.

The dry film thickness of the effect coating film is preferably 0.2 to 5 μm, more preferably 0.3 to 3 μm, and particularly preferably 0.5 to 2 μm, in terms of obtaining a coating film with excellent pearl luster.

In the present specification, the dry film thickness is calculated from the following Equation (3).

x=(sc*10000)/(S*sg) (Equation 3)

x: film thickness [μm]
sc: coating solids content [g]
S: evaluation area of coating solids content [cm²]
sg: coating film specific gravity [g/cm³]

### 3. Step (3)

Step (3) is to apply a clear paint (Z) to the effect coating film formed in step (2) to form a clear coating film.

### Clear Paint (Z)

The clear paint (Z) may be a one-component clear paint containing a base resin and a curing agent, or a two-component clear paint having a hydroxy-containing resin and a polyisocyanate compound.

The clear paint (Z) is preferably a two-component clear paint having a hydroxy-containing resin and an isocyanate group-containing compound, in terms of the adhesion and pearl luster of the multilayer coating film to be obtained.

### Hydroxy-Containing Resin

As the hydroxy-containing resin, conventionally known resins can be used without limitation, as long as they are resins containing a hydroxyl group. Examples of the hydroxy-containing resin include hydroxy-containing acrylic resins, hydroxy-containing polyester resins, hydroxy-containing polyether resins, hydroxy-containing polyurethane resins, and the like; preferably hydroxy-containing acrylic resins and hydroxy-containing polyester resins; and particularly preferably hydroxy-containing acrylic resins.

The hydroxy value of the hydroxy-containing acrylic resin is preferably within the range of 80 to 200 mgKOH/g, and more preferably 100 to 180 mgKOH/g. When the hydroxy value is 80 mgKOH/g or more, the crosslinking density is high, and thus the scratch resistance is sufficient. Further, when the hydroxy value is 200 mgKOH/g or less, the water resistance of the coating film is satisfied.

The weight average molecular weight of the hydroxy-containing acrylic resin is preferably within the range of 2500 to 40000, and more preferably 5000 to 30000. When the weight average molecular weight is 2500 or more, the coating film performance, such as acid resistance, is satisfied. When the weight average molecular weight is 40000 or less, the smoothness of the coating film is sufficient, and thus the finish is satisfied.

In the present specification, the weight average molecular weight refers to a value calculated from a chromatogram measured by gel permeation chromatography based on the molecular weight of standard polystyrene. For the gel permeation chromatography, “HLC8120GPC” (produced by Tosoh Corporation) was used. The measurement was conducted using four columns: “TSKgel G-4000HXL,” “TSKgel G-3000HXL,” “TSKgel G-2500HXL,” and “TSKgel G-2000HXL” (trade names, all produced by Tosoh Corporation) under the conditions of mobile phase: tetrahydrofuran, measuring temperature: 40° C., flow rate: 1 cc/min, and detector: RI.

The glass transition temperature of the hydroxy-containing acrylic resin is −40° C. to 20° C., and particularly preferably −30° C. to 10° C. When the glass transition temperature is −40° C. or more, the coating film hardness is sufficient. When the glass transition temperature is 20° C. or less, the coating surface smoothness of the coating film is satisfied.

### Polyisocyanate Compound

The polyisocyanate compound is a compound having at least two isocyanate groups per molecule. Examples include aliphatic polyisocyanates, alicyclic polyisocyanates, aromatic-aliphatic polyisocyanates, aromatic polyisocyanates, derivatives of these polyisocyanates, and the like.

Examples of aliphatic polyisocyanates include aliphatic diisocyanates, such as trimethylene diisocyanate, tetramethylene diisocyanate, hexamethylene diisocyanate, pentamethylene diisocyanate, 1,2-propylene diisocyanate, 1,2-butylene diisocyanate, 2,3-butylene diisocyanate, 1,3-butylene diisocyanate, 2,4,4- or 2,2,4-trimethylhexamethylene diisocyanate, dimer acid diisocyanate, and methyl 2,6-diisocyanatohexanoate (common name: lysine diisocyanate); aliphatic triisocyanates, such as 2-isocyanatoethyl 2,6-diisocyanatohexanoate, 1,6-diisocyanato-3-isocyanatomethylhexane, 1,4,8-triisocyanatooctane, 1,6,11-triisocyanatoundecane, 1,8-diisocyanato-4-isocyanatomethyloctane, 1,3,6-triisocyanatohexane, and 2,5,7-trimethyl-1,8-diisocyanato-5-isocyanatomethyloctane; and the like.

Examples of alicyclic polyisocyanates include alicyclic diisocyanates, such as 1,3-cyclopentene diisocyanate, 1,4-cyclohexane diisocyanate, 1,3-cyclohexane diisocyanate, 3-isocyanatomethyl-3,5,5-trimethylcyclohexyl isocyanate (common name: isophorone diisocyanate), 4-methyl-1,3-cyclohexylene diisocyanate (common name: hydrogenated TDI), 2-methyl-1,3-cyclohexylene diisocyanate, 1,3- or 1,4-bis(isocyanatomethyl)cyclohexane (common name: hydrogenated xylylene diisocyanate) or mixtures thereof, and methylenebis(4,1-cyclohexanediyl)diisocyanate (common name: hydrogenated MDI), and norbornane diisocyanate; alicyclic triisocyanates, such as 1,3,5-triisocyanatocyclohexane, 1,3,5-trimethylisocyanatocyclohexane, 2-(3-isocyanatopropyl)-2,5-di(isocyanatomethyl)-bicyclo(2.2.1)heptane, 2-(3-isocyanatopropyl)-2,6-di(isocyanatomethyl)-bicyclo(2.2.1)heptane, 3-(3-isocyanatopropyl)-2,5-di(isocyanatomethyl)-bicyclo(2.2.1)heptane, 5-(2-isocyanatoethyl)-2-isocyanatomethy-3-(3-isocyanatopropyl)-bicyclo(2.2.1)heptane, 6-(2-isocyanatoethyl)-2-isocyanatomethyl-3-(3-isocyanatopropyl)-bicyclo(2.2.1)heptane, 5-(2-isocyanatoethyl)-2-isocyanatomethyl-2-(3-isocyanatopropyl)-bicyclo(2.2.1)heptane, and 6-(2-isocyanatoethyl)-2-isocyanatomethyl-2-(3-isocyanatopropyl)-bicyclo(2.2.1)heptane; and the like.

Examples of aromatic-aliphatic polyisocyanates include aromatic-aliphatic diisocyanates, such as methylenebis(4,1-phenylene)diisocyanate (common name: MDI), 1,3- or 1,4-xylylene diisocyanate or mixtures thereof, ω,ω′-diisocyanato-1,4-diethylbenzene, and 1,3- or 1,4-bis(1-isocyanato-1-methylethyl)benzene (common name: tetramethylxylylene diisocyanate) or mixtures thereof; aromatic-aliphatic triisocyanates, such as 1,3,5-triisocyanatomethylbenzene; and the like.

Examples of aromatic polyisocyanates include aromatic diisocyanates, such as m-phenylene diisocyanate, p-phenylene diisocyanate, 4,4′-diphenyl diisocyanate, 1,5-naphthalene diisocyanate, 2,4-tolylene diisocyanate (common name: 2,4-TDI), or 2,6-tolylene diisocyanate (common name: 2,6-TDI) or mixtures thereof, 4,4′-toluidine diisocyanate, and 4,4′-diphenylether diisocyanate; aromatic triisocyanates, such as triphenylmethane-4,4′,4″-triisocyanate, 1,3,5-triisocyanatobenzene, and 2,4,6-triisocyanatotoluene; aromatic tetraisocyanates, such as 4,4′-diphenylmethane-2,2′,5,5′-tetraisocyanate; and the like.

Examples of polyisocyanate derivatives include dimers, trimers, biurets, allophanates, urethodiones, urethoimines, isocyanurates, oxadiazinetriones, polymethylene polyphenyl polyisocyanates (crude MDI, polymeric MDI), crude TDI, and the like, of the above-mentioned polyisocyanates. These polyisocyanate derivatives can be used singly, or in a combination of two or more.

The above polyisocyanates and derivatives thereof can be used singly, or in a combination of two or more.

Among the aliphatic diisocyanates, hexamethylene diisocyanate or derivatives thereof are preferably used. Among the alicyclic diisocyanates, 4,4′-methylenebis(cyclohexyl isocyanate) is preferably used. Of these, derivatives of hexamethylene diisocyanate are particularly the most preferable, in terms of adhesion, compatibility, and the like.

As the polyisocyanate compound, a prepolymer is also usable that is formed by reacting the polyisocyanate or a derivative thereof with a compound that has active hydrogen, such as a hydroxyl group or an amino group, and that is reactive to the polyisocyanate under conditions such that the isocyanate groups are present in excess. Examples of the compound that is reactive to the polyisocyanate include polyhydric alcohols, low-molecular-weight polyester resins, amine, water, and the like.

The polyisocyanate compound for use may be a blocked polyisocyanate compound in which some or all of the isocyanate groups of the above polyisocyanate or a derivative thereof are blocked with a blocking agent.

Examples of the blocking agent include phenol-based blocking agents, lactam-based blocking agents, aliphatic alcohol-based blocking agents, ether-based blocking agents, alcohol-based blocking agents, oxime-based blocking agents, active methylene-based blocking agents, mercaptan-based blocking agents, acid amide-based blocking agents, imide-based blocking agents, amine-based blocking agents, imidazole-based blocking agents, urea-based blocking agents, carbamate-based blocking agents, imine-based blocking agents, sulfite-based blocking agents, azole-based compounds, and the like.

Examples of phenol-based blocking agents include phenol, cresol, xylenol, nitrophenol, ethylphenol, hydroxydiphenyl, butylphenol, isopropylphenol, nonylphenol, octylphenol, methyl hydroxybenzoate, and the like.

Examples of lactam-based blocking agents include ε-caprolactam, δ-valerolactam, γ-butyrolactam, β-propiolactam, and the like.

Examples of aliphatic alcohol-based blocking agents include methanol, ethanol, propyl alcohol, butyl alcohol, amyl alcohol, lauryl alcohol, and the like.

Examples of ether-based blocking agents include ethylene glycol monomethyl ether, ethylene glycol monoethyl ether, ethylene glycol monobutyl ether, diethylene glycol monomethyl ether, diethylene glycol monoethyl ether, propylene glycol monomethyl ether, methoxymethanol, and the like.

Examples of alcohol-based blocking agents include benzyl alcohol, glycolic acid, methyl glycolate, ethyl glycolate, butyl glycolate, lactic acid, methyl lactate, ethyl lactate, butyl lactate, methylol urea, methylol melamine, diacetone alcohol, 2-hydroxyethyl acrylate, 2-hydroxyethyl methacrylate, and the like.

Examples of oxime-based blocking agents include formamide oxime, acetamide oxime, acetoxime, methyl ethyl ketoxime, diacetyl monoxime, benzophenone oxime, cyclohexane oxime, and the like.

Examples of active methylene-based blocking agents include dimethyl malonate, diethyl malonate, ethyl acetoacetate, methyl acetoacetate, acetylacetone, and the like.

Examples of mercaptan-based blocking agents include butyl mercaptan, t-butyl mercaptan, hexyl mercaptan, t-dodecyl mercaptan, 2-mercaptobenzothiazole, thiophenol, methylthiophenol, ethylthiophenol, and the like.

Examples of acid amide-based blocking agents include acetanilide, acetanisidide, acetotoluide, acrylamide, methacrylamide, acetic acid amide, stearic acid amide, benzamide, and the like.

Examples of imide-based blocking agents include succinimide, phthalimide, maleimide, and the like.

Examples of amine-based blocking agents include diphenylamine, phenylnaphthylamine, xylidine, N-phenylxylidine, carbazole, aniline, naphthylamine, butylamine, dibutylamine, butylphenylamine, and the like.

Examples of imidazole-based blocking agents include imidazole, 2-ethylimidazole, and the like.

Examples of urea-based blocking agents include urea, thiourea, ethyleneurea, ethylenethiourea, diphenylurea, and the like.

Examples of carbamate-based blocking agents include phenyl N-phenylcarbamate and the like.

Examples of imine-based blocking agents include ethyleneimine, propyleneimine, and the like.

Examples of sulfite-based blocking agents include sodium bisulfite, potassium bisulfite, and the like.

Examples of azole-based compounds include pyrazole or pyrazole derivatives, such as pyrazole, 3,5-dimethylpyrazole, 3-methylpyrazole, 4-benzyl-3,5-dimethylpyrazole, 4-nitro-3,5-dimethylpyrazole, 4-bromo-3,5-dimethylpyrazole, and 3-methyl-5-phenylpyrazole; imidazole or imidazole derivatives, such as imidazole, benzimidazole, 2-methylimidazole, 2-ethylimidazole, and 2-phenylimidazole; and imidazoline derivatives, such as 2-methylimidazoline and 2-phenylimidazoline.

When blocking is performed (a blocking agent is reacted), it can be performed by adding a solvent, if necessary. As the solvent used in the blocking reaction, a solvent that is not reactive with an isocyanate group is preferably used. Examples include ketones, such as acetone and methyl ethyl ketone; esters, such as ethyl acetate; N-methyl-2-pyrrolidone (NMP); and like solvents. The polyisocyanate compounds can be used singly, or in a combination of two or more.

The polyisocyanate compounds can be used singly, or in a combination of two or more. In the two-component clear paint of the present invention, the equivalent ratio of the hydroxy groups in the hydroxy-containing resin to the isocyanate groups in the polyisocyanate compound (NCO/OH) is preferably within the range of 0.5 to 2.0, and more preferably 0.8 to 1.5, in terms of the curability and scratch resistance of the coating film.

Examples of combinations of a base resin and a curing agent in the one-component clear paint include a carboxy-containing resin and an epoxy-containing resin, a hydroxy-containing resin and a blocked polyisocyanate compound, a hydroxy-containing resin and a melamine resin, and the like. When a one-component paint is used as the clear paint (Z), the clear paint (Z) preferably contains a crosslinkable component (D) in terms of the anti-water adhesion of the coating film to be obtained. In particular, when the effect pigment dispersion (Y) does not contain a crosslinkable component (D), the clear paint (Z) preferably contains a crosslinkable component (D).

As the crosslinkable component (D), those described in the “Effect Pigment Dispersion (Y)” section can be used.

When the clear paint (Z) contains the crosslinkable component (D), the content thereof as a solids content is preferably within the range of 5 to 60 parts by mass, more preferably 10 to 50 parts by mass, and even more preferably 15 to 40 parts by mass, based on 100 parts by mass of the resin solids content of the clear paint (Z), in terms of the anti-water adhesion of the coating film.

The clear paint (Z) may suitably contain additives, such as solvents (e.g., water and organic solvents), curing catalysts, antifoaming agents, and ultraviolet absorbers, if necessary.

The clear paint (Z) may suitably contain a color pigment within a range that does not impair transparency. As the color pigment, conventionally known pigments for ink or paints can be used singly, or in a combination of two or more. The amount thereof to be added may be suitably determined; however, it is preferably 30 parts by mass or less, and more preferably 0.01 to 10 parts by mass, based on 100 parts by mass of the vehicle-forming resin composition in the clear paint (Z).

The form of the clear paint (Z) is not particularly limited. The clear paint (Z) is generally used as an organic solvent-based paint composition. Examples of the organic solvent used in this case include various organic solvents for paints, such as aromatic or aliphatic hydrocarbon solvents, ester solvents, ketone solvents, and ether solvents. As the organic solvent, the solvent used in the preparation of the hydroxy-containing resin can be used as is; or one or more other organic solvents may be added appropriately, and the resulting mixed solvent can be used.

The solids concentration of the clear paint (Z) is preferably about 30 to 70 mass %, and more preferably about 40 to 60 mass %.

The clear paint (Z) is applied to the effect coating film. The coating of the clear paint (Z) is not particularly limited, and the same method as those for the colored paint (X) and the effect pigment dispersion (Y) can be used. For example, the clear paint (Z) can be applied by a coating method, such as air spray coating, airless spray coating, rotary atomization coating, or curtain coating. In these coating methods, an electrostatic charge may be applied, if necessary. Among these, rotary atomization coating using an electrostatic charge is preferable. In general, the coating amount of the clear paint (Z) is preferably an amount that achieves a cured film thickness of about 10 to 50 μm.

Moreover, when the clear paint (Z) is applied, it is preferable to appropriately adjust the viscosity of the clear paint (Z) within a viscosity range suitable for the coating method. For example, for rotary atomization coating using an electrostatic charge, it is preferable to appropriately adjust the viscosity of the clear paint (Z) within a range of about 15 to 60 seconds as measured by a Ford cup No. 4 viscometer at 20° C. using a solvent, such as an organic solvent.

After the clear paint (Z) is applied to form a clear coating film, for example, preheating can be performed at a temperature of about 50 to 80° C. for about 3 to 10 minutes so as to promote the vaporization of volatile components.

### 4. Step (4)

Step (4) is to heat the yellow coating film, the effect coating film, and the clear coating film formed in steps (1) to (3) to separately or simultaneously cure these three coating films.

Heating can be performed by a known means. For example, a drying furnace, such as a hot-blast stove, an electric furnace, or an infrared beam heating furnace can be used. The heating temperature is preferably within the range of 70 to 150° C., and more preferably 80 to 140° C. The heating time is not particularly limited; however, it is preferably within the range of 10 to 40 minutes, and more preferably 20 to 30 minutes.

The multilayer coating film obtained in the present invention has a bright, vivid yellow color with a pearl-like luster. Pearl-like luster (hereinafter briefly referred to as “pearl luster”) is a texture with strong multiple reflection light of irradiated light, and preferably low graininess. In general, the intensity of multiple reflection light of irradiated light is expressed by a Y value that expresses luminance in the XYZ color space. Particularly in the present specification, pearl luster is evaluated using a Y5 value that is characteristic to pearl luster. The Y5 value refers to luminance in the XYZ color space based on the spectral reflectance of light illuminated at an angle of 45 degrees with respect to the coating film, and received at an angle of 5 degrees deviated from specular reflection light in the incident light direction. The multilayer coating film obtained in the present invention has a Y5 value of 200 or more and preferably 400 to 1000 in view of pearl luster. If the Y5 value of the multilayer coating is less than 200, the multilayer coating has poor pearl luster.

The graininess is represented by a hi-light graininess value (hereinafter abbreviated as the “HG value”). The HG value is an indicator of microscopic brilliance obtained by microscopic observation, and indicates the graininess in the highlight (observation of the laminate film from the vicinity of the specular reflection light against incident light). The HG value is calculated as follows. First, the coating film is photographed with a CCD camera at a light incidence angle of 15° and a receiving angle of 0°; and the obtained digital image data, i.e., two-dimensional luminance distribution data, are subjected to a two-dimensional Fourier transform to obtain a power spectrum image. Subsequently, only the spatial frequency area corresponding to graininess is extracted from the power spectrum image, and the obtained measurement parameter is converted to an HG value from 0 to 100 that has a linear relation with graininess. An HG value of “0” indicates no graininess, and an HG value of almost “100” indicates the highest possible graininess.

The multilayer coating film of the present invention preferably has an HG value of 60 or less, more preferably 0 to 55, and even more preferably 1 to 50. Thus, a laminate film having low graininess and exhibiting a color with a delicate impression can be obtained. When the HG value exceeds 60, a laminate film having low graininess and exhibiting a color with a delicate impression cannot be obtained in some cases.

The multilayer coating film obtained in the present invention is yellow in color. The coating film being yellow in color means that the hue angle h in the L*C*h color space diagram calculated from the spectral reflectance of light illuminated at an angle of 45 degrees with respect to the obtained coating film and received at angles of 45 degrees deviated from the specular reflection light, using a multi-angle spectrophotometer (trade name: MA-68II, produced by X-Rite Inc.) is within the range of 60° to 120°, preferably 70° to 110, when the a* red direction is defined as 0°.

The L*C*h color space referred to herein is a color space devised from the L*a*b* color space, which was standardized in 1976 by the Commission Internationale de l'Eclairage and also adopted in JIS Z 8729.

The multilayer coating film obtained by the present invention has a CS value, as represented by Formula 1, of 90 or more, preferably 100 or more.

CS=[(L*110)²+(C*110)²]^{1/2} (Formula 1)

L* and C* respectively indicate lightness and chroma in the L*a*b* color space, which was standardized in 1976 by the Commission Internationale de l'Eclairage and also adopted in JIS Z 8729.

L*110 is defined as a numerical value of lightness calculated from the spectral reflectance of light illuminated at an angle of 45 degrees with respect to the obtained coating film and received at an angle of 110 degrees deviated from the specular reflection light, using a multi-angle spectrophotometer (trade name: MA-68II, produced by X-Rite Inc.).

C*110 is defined as a numerical value of chroma calculated from the spectral reflectance of light illuminated at an angle of 45 degrees with respect to the obtained coating film and received at an angle of 110 degrees deviated from the specular reflection light, using a multi-angle spectrophotometer (trade name: MA-68II, produced by X-Rite Inc.).

L*110 and C*110 are lightness and chroma of a coating film in the shade perceived by an observer viewing the coating film. CS is a scale that combines chroma and lightness of a coating film in the shade to evaluate color. When the CS value is 90 or more, a bright, vivid multilayer coating can be provided.

The present invention may also adopt the following embodiments.

[1] A method for forming a multilayer coating film, comprising:

(1) applying a yellow pigment-containing paint (X) to a substrate to form at least one layer of a yellow coating film;

(2) applying an effect pigment dispersion (Y) to the yellow coating film to form an effect coating film;

(3) applying a clear paint (Z) to the effect coating film to form a clear coating film; and

(4) heating the yellow coating film, the effect coating film, and the clear coating film to separately or simultaneously cure the coating films,

wherein the yellow pigment contained in the yellow coating film has an optical density of 750 to 7000, wherein the optical density is a value obtained by multiplying the pigment concentration by the film thickness,

the effect pigment dispersion (Y) contains water, a rheology control agent (A), and an interference flake-effect pigment (B),

the multilayer coating film has an h value of 60 to 120°,

the multilayer coating film has a Y5 value of 200 or more, and

the multilayer coating film has a CS value of 90 or more, wherein the CS value is expressed by Equation 1:

CS=[(L*110)²+(C*110)²]^{1/2} (Equation 1).

[2] The method for forming a multilayer coating film according to [1], wherein step (2) comprises directly applying the effect pigment dispersion (Y) to the yellow coating film.
[3] The method for forming a multilayer coating film according to [1], wherein step (1) further comprises applying a transparent base paint (X) to the yellow coating film to form a transparent base coating film, and step (2) comprises applying the effect pigment dispersion (Y) to the transparent base coating film.
[4] The method for forming a multilayer coating film according to any one of [1] to [3], wherein the yellow coating film is a yellow intermediate coating film or a yellow base coating film.
[5] The method for forming a multilayer coating film according to any one of [1] to [4], wherein the yellow coating film is a two-layered yellow coating film.
[6] The method for forming a multilayer coating film according to [5], wherein the two-layered yellow coating film is a two-layered yellow intermediate coating film; a yellow intermediate coating film and a yellow base coating film formed on the yellow intermediate coating film; or a two-layered yellow base coating film.
[7] The method for forming a multilayer coating film according to any one of [1] to [5], wherein the measurement value of graininess (HG value) is 60 or less.
[8] The method for forming a multilayer coating film according to any one of [1] to [7], wherein the yellow pigment contains bismuth vanadate.
[9] The method for forming a multilayer coating film according to any one of [1] to [8], wherein the rheology control agent (A) is a cellulose nanofiber.
[10] The method for forming a multilayer coating film according to any one of [1] to [9], wherein the interference flake-effect pigment (B) is one or more pigments whose interference color is selected from an achromatic color, gold, and green.
[11] The method for forming a multilayer coating film according to any one of [1] to [10], wherein the clear paint (Z) is a two-component clear paint containing a hydroxy-containing resin and a polyisocyanate compound.
[12] The method for forming a multilayer coating film according to any one of [1] to [11], wherein the one or more layers of the yellow coating film each have a cured film thickness of 5 to 50 μm.
[13] The method for forming a multilayer coating film according to any one of [1] to [12], wherein the effect coating film has a dry film thickness of 0.2 to 5 μm.
[14] A multilayer coating film to be formed on a substrate, comprising:

at least one layer of a yellow coating film containing a yellow pigment;

an effect coating film formed on the yellow coating film; and

a clear coating film formed on the effect coating film,

wherein the yellow pigment contained in the yellow coating film has an optical density of 750 to 7000, wherein the optical density is a value obtained by multiplying the pigment concentration by the film thickness,

the effect coating film contains a rheology control agent (A) and an interference flake-effect pigment (B),

the multilayer coating film has an h value of 60 to 120,

the multilayer coating film has a Y5 value of 200 or more, and

the multilayer coating film has a CS value of 90 or more, wherein the CS value is expressed by Equation 1:

CS=[(L*110)=+(C*110)²]^{1/2} (Equation 1).

[15] The multilayer coating film according to [14], wherein the effect pigment dispersion is directly formed on the yellow coating film.
[16] The multilayer coating film according to [14], wherein the multilayer coating film further comprises a transparent base coating film formed on the yellow coating film, and the effect coating film is formed on the transparent base coating film.
[17] The multilayer coating film according to any one of [14] to [16], wherein the yellow coating film is a yellow intermediate coating film or a yellow base coating film.
[18] The multilayer coating film according to any one of [14] to [17], wherein the yellow coating film is a two-layered yellow coating film.
[19] The multilayer coating film according to [18], wherein the two-layered yellow coating film is a two-layered yellow intermediate coating film; a yellow intermediate coating film and a yellow base coating film formed on the yellow intermediate coating film; or a two-layered yellow base coating film.
[20] The multilayer coating film according to [18], wherein the yellow coating film is a two-layered yellow base coating film, and a yellow base coating film, a clear coating film, and a yellow base coating film are laminated in this order on a substrate.
[21] The multilayer coating film according to [20], wherein the yellow base coating film is directly formed on the substrate.
[22] The multilayer coating film according to [20], further comprising a yellow intermediate coating film between the substrate and the yellow base coating film.
[23] The multilayer coating film according to any one of [14] to [22], wherein the measurement value of graininess (HG value) is 60 or less.
[24] The multilayer coating film according to any one of [14] to [23], wherein the yellow pigment contains bismuth vanadate.
[25] The multilayer coating film according to any one of [14] to [24], wherein the rheology control agent (A) is a cellulose nanofiber.
[26] The multilayer coating film according to any one of [14] to [25], wherein the interference flake-effect pigment (B) is one or more pigments whose interference color is selected from an achromatic color, gold, and green.
[27] The multilayer coating film according to any one of [14] to [26], wherein the clear coating film is obtained by applying a two-component clear paint containing a hydroxy-containing resin and a polyisocyanate compound.
[28] The method for forming a multilayer coating film according to any one of [14] to [27], wherein the one or more layers of the yellow coating film each have a cured film thickness of 5 to 50 μm.
[29] The method for forming a multilayer coating film according to any one of [14] to [28], wherein the effect coating film has a dry film thickness of 0.2 to 5 μm.

### EXAMPLES

The present invention is described in more detail below with reference to Examples and Comparative Examples. However, the present invention is not limited only to these Examples. “Part(s)” and “%” are both based on mass.

### Production of Acrylic Resin Aqueous Dispersion (R-1)

### Production Example 1

128 parts of deionized water and 2 parts of “Adeka Reasoap SR-1025” (trade name, produced by Adeka, emulsifier, active ingredient: 25%) were placed in a reaction vessel equipped with a thermometer, a thermostat, a stirrer, a reflux condenser, a nitrogen inlet tube, and a dropping funnel. The mixture was stirred and mixed in a nitrogen flow, and heated to 80° C.

Subsequently, 1% of the entire amount of a monomer emulsion for the core portion, which is described below, and 5.3 parts of a 6% ammonium persulfate aqueous solution were introduced into the reaction vessel, and maintained therein at 80° C. for 15 minutes. Thereafter, the remaining monomer emulsion for the core portion was added dropwise over a period of 3 hours to the reaction vessel maintained at the same temperature. After completion of the dropwise addition, the mixture was aged for 1 hour. A monomer emulsion for the shell portion, which is described below, was then added dropwise over a period of 1 hour, followed by aging for 1 hour. Thereafter, the mixture was cooled to 30° C. while gradually adding 40 parts of a 5% 2-(dimethylamino)ethanol aqueous solution thereto; and filtered through a 100-mesh nylon cloth, thereby obtaining an acrylic resin aqueous dispersion (R-1) having an average particle size of 100 nm and a solids content of 30%. The obtained acrylic resin aqueous dispersion had an acid value of 33 mgKOH/g and a hydroxy value of 25 mgKOH/g.

Monomer emulsion for the core portion: The monomer emulsion for the core portion was obtained by mixing and stirring 40 parts of deionized water, 2.8 parts of “Adeka Reascap SR-1025,” 2.1 parts of methylene bisacrylamide, 2.8 parts of styrene, 16.1 parts of methyl methacrylate, 28 parts of ethyl acrylate, and 21 parts of n-butyl acrylate.

Monomer emulsion for the shell portion: The monomer emulsion for the shell portion was obtained by mixing and stirring 17 parts of deionized water, 1.2 parts of “Adeka Reasoap SR-1025”, 0.03 parts of ammonium persulfate, 3 parts of styrene, 5.1 parts of 2-hydroxyethyl acrylate, 5.1 parts of methacrylic acid, 6 parts of methyl methacrylate, 1.8 parts of ethyl acrylate, and 9 parts of n-butyl acrylate.

### Production of Acrylic Resin Solution (R-2)

### Production Example 2

35 parts of propylene glycol monopropyl ether was placed into a reaction vessel equipped with a thermometer, a thermostat, a stirrer, a reflux condenser, a nitrogen inlet tube, and a dropping funnel; and heated to 85° C. A mixture comprising 30 parts of methyl methacrylate, 20 parts of 2-ethylhexyl acrylate, 29 parts of n-butyl acrylate, 15 parts of 2-hydroxyethyl acrylate, 6 parts of acrylic acid, 15 parts of propylene glycol monopropyl ether, and 2.3 parts of 2,2′-azobis(2,4-dimethylvaleronitrile) was then added dropwise thereto over a period of 4 hours. After completion of the dropwise addition, the mixture was aged for 1 hour. Further, a mixture of 10 parts of propylene glycol monopropyl ether and 1 part of 2,2′-azobis(2,4-dimethylvaleronitrile) was added dropwise thereto over a period of 1 hour. After completion of the dropwise addition, the mixture was aged for 1 hour. Further, 7.4 parts of diethanolamine was added thereto, thereby obtaining an acrylic resin solution (R-2) having a solids content of 55%. The obtained hydroxy-containing acrylic resin had an acid value of 47 mgKOH/g, a hydroxy value of 72 mgKOH/g, and a weight average molecular weight of 58000.

### Production of Polyester Resin Solution (R-3)

### Production Example 3

109 parts of trimethylolpropane, 141 parts of 1,6-hexanediol, 126 parts of 1,2-cyclohexanedicarboxylic acid anhydride, and 120 parts of adipic acid were placed into a reaction vessel equipped with a thermometer, a thermostat, a stirrer, a reflux condenser, and a water separator. The mixture was heated from 160° C. to 230° C. over a period of 3 hours, followed by a condensation reaction at 230° C. for 4 hours. Subsequently, to introduce a carboxyl group to the obtained condensation reaction product, 38.3 parts of trimellitic anhydride was added to the product, followed by a reaction at 170° C. for 30 minutes. Thereafter, the product was diluted with 2-ethyl-1-hexanol, thereby obtaining a polyester resin solution (R-3) having a solids content of 70%. The obtained hydroxy-containing polyester resin had an acid value of 46 mgKOH/g, a hydroxy value of 150 mgKOH/g, and a number average molecular weight of 1400.

### Production of Extender Pigment Dispersion

### Production Example 4

327 parts (solids content: 180 parts) of the acrylic resin solution (R-2), 360 parts of deionized water, 6 parts of Surfynol 104A (trade name, produced by Air Products, antifoaming agent, solids content: 50%), and 250 parts of Barifine BF-20 (trade name, produced by Sakai Chemical Industry Co., Ltd., barium sulfate powder, average particle size: 0.03 μm) were placed in a paint conditioner, and a glass bead medium was added thereto. The mixture was mixed and dispersed at room temperature for 1 hour, thereby obtaining an extender pigment dispersion (P-1) having a solids content of 44%.

### Preparation of Yellow Pigment Dispersion

### Production Example 5

182 parts (solids content: 100 parts) of the acrylic resin solution (R-2), 500 parts of “Yellow 2GLMA” (trade name, produced by Dominion Color Corporation, bismuth vanadate yellow pigment), and 500 parts of deionized water were mixed. After the mixture was adjusted to pH 8.5 using 2-(dimethylamino)ethanol, the mixture was dispersed in a paint shaker for 2 hours, thereby obtaining a yellow pigment dispersion (P-2) having a solids content of 50.8%.

### Production of White Pigment Dispersion

### Production Example 6

182 parts (solids content: 100 parts) of the acrylic resin solution (R-2), 500 parts of “Titanix JR-806” (trade name, produced by Tayca Co., Ltd., titanium oxide), and 500 parts of deionized water were mixed. After the mixture was adjusted to pH 8.5 using 2-(dimethylamino)ethanol, the mixture was dispersed in a paint shaker for 2 hours, thereby obtaining a white pigment dispersion (P-3) having a solids content of 50.8%.

### Production of Transparent Base Paint (W-1)

### Production Example 7

In a stirring vessel, 14 parts (on a solids basis) of the extender pigment dispersion (P-1), 40 parts (on a solids basis) of the acrylic resin aqueous dispersion (R-1), 23 parts (on a solids basis) of the polyester resin solution (R-3), 10 parts (on a solids basis) of “U-Coat UX-310” (trade name, produced by Sanyo Chemical Industries, Ltd., urethane resin aqueous dispersion, solids content: 40%), and 27 parts (on a solids basis) of “Cymel 251” (trade name, produced by Nihon Cytec Industries Inc., melamine resin, solids content: 80%) were stirred and mixed, thereby preparing a transparent base paint (W-1).

### Production of Yellow Paint (X)

### Yellow Intermediate Paint (X-1)

### Production Example 8

WP522H enamel clear paint (product name, produced by Kansai Paint Co., Ltd., aqueous intermediate paint) was placed in a stirring vessel. The yellow pigment dispersion (P-2) and the white pigment dispersion (P-3) were added in amounts such that 100 parts by mass of Yellow 2GLMA and 20 parts of Titanix JR-806 were present per 100 parts by mass of the resin solids content of WP522H. The resulting mixture was stirred and mixed, thereby preparing a yellow intermediate paint (X-1).

### Production of Yellow Base Paint (X-2)

### Production Example 9

The transparent base paint (W-1) was placed in a stirring vessel. The yellow pigment dispersion (P-2) was added in an amount such that 75 parts by mass of Yellow 2GLMA was present per 100 parts by mass of the resin in the transparent base paint (W-1). The resulting mixture was stirred and mixed, thereby preparing a yellow base paint (X-2).

### Production of Yellow Intermediate Paint (X-3)

### Production Example 10

WP522H enamel clear paint (product name, produced by Kansai Paint Co., Ltd., aqueous intermediate paint) was placed in a stirring vessel. The yellow pigment dispersion (P-2) and the white pigment dispersion (P-3) were added in amounts such that 120 parts by mass of Yellow 2GLMA and 20 parts of Titanix JR-806 were present per 100 parts by mass of the resin solids content of WP522H. The resulting mixture was stirred and mixed, thereby preparing a yellow intermediate paint (X-3).

### Production of Yellow Intermediate Paint (X-4)

### Production Example 11

WP522H enamel clear paint (product name, produced by Kansai Paint Co., Ltd., aqueous intermediate paint) was placed in a stirring vessel. The yellow pigment dispersion (P-2) and the white pigment dispersion (P-3) were added in amounts such that 28 mass parts of Yellow 2GLMA and 20 parts of Titanix JR-806 were present per 100 parts by mass of the resin solids content of WP522H. The resulting mixture was stirred and mixed, thereby preparing a yellow intermediate paint (X-4).

### Preparation of Yellow Base Coating Composition (X-5)

### Production Example 12

The transparent base paint (W-1) was placed in a stirring vessel, and the yellow pigment dispersion (P-2) was added in an amount such that 200 parts by mass of Yellow 2GLMA was present per 100 parts by mass of the resin of the base paint (W-1). The resulting mixture was stirred and mixed, thereby preparing a yellow base paint (X-5).

### Production of Yellow Base Paint (X-6)

### Production Example 13

The transparent base paint (W-1) was placed in a stirring vessel. The yellow pigment dispersion (P-2) was added in an amount such that 70 parts by mass of Yellow 2GLMA was present per 100 mass parts of the resin of the base paint (W-1). The resulting mixture was stirred and mixed, thereby preparing a yellow base paint (X-6).

### Production of Yellow Intermediate Paint (X-7)

### Production Example 14

WP522H enamel clear paint (product name, produced by Kansai Paint Co., Ltd., aqueous intermediate paint) was placed. The yellow pigment dispersion (P-2) and the white pigment dispersion (P-3) were added in amounts such that 200 mass parts of Yellow 2GLMA and 20 parts of Titanix JR-806 were present per 100 parts by mass of the resin solids content of WP522H. The resulting mixture was stirred and mixed, thereby preparing a yellow intermediate paint (X-7).

### Production of Yellow Base Paint (X-8)

### Production Example 15

The transparent base paint (W-1) was placed in a stirring vessel. The yellow pigment dispersion (P-2) was added in an amount such that 300 parts by mass of Yellow 2GLMA was present per 100 parts by mass of the resin of the base paint (W-1). The resulting mixture was stirred and mixed, thereby preparing a yellow base paint (X-8).

### Production of Effect Pigment Dispersion (Y)

### Production Example 16

In a stirring vessel, 40 parts of distilled water, 15 parts (solids content: 0.3 parts) of a rheology control agent (A-1), 1.3 parts (solids content: 1.3 parts) of a flake-effect pigment (B-1), 0.5 parts (solids content: 0.5 part) of a surface adjusting agent (C-1), and 0.5 parts of ethylene glycol monobutyl ether were placed. The resulting mixture was stirred and mixed, thereby preparing an effect pigment dispersion (Y-1).

The rheology control agent (A-1), the flake-effect pigment (B-1), and the surface adjusting agent (C-1) are as follows.

(A-1) “Rheocrysta” (trade name, produced by DKS Co. Ltd., cellulose nanofiber, solids content: 2%)
(B-1) “Xirallic T60-10 Crystal Silver” (trade name, titanium oxide-coated alumina flake pigment, produced by Merck & Co., Inc., average primary particle size: about 19 μm, thickness: about 0.4 μm)
(C-1) “BYK348” (trade name, produced by BYK, silicone-based, dynamic surface tension: 63.9 mN/m, static surface tension: 22.2 mN/m, lamellar length: 7.45 mm, contact angle (Note 1): 13°, solids content: 100%)
Note 1: A contact angle with respect to a tin plate 10 seconds after application of a mixed solution prepared by mixing isopropanol, water, and the surface adjusting agent (C) at a mass ratio of 4.5/95/1; and being adjusted to have a viscosity of 150 mPa·s measured by a Brookfield-type viscometer at a rotor rotational speed of 60 rpm and at a temperature of 20° C.

### Production Examples 17 to 24

Effect pigment dispersions (Y-2) to (Y-9) were obtained in the same manner as in Production Example 16, except that the formulations shown in Table 1 were used.

In Table 1, the numerical values for distilled water, dimethylethanolamine, and ethylene glycol monobutyl ether indicate the liquid amount; and the numerical values for the others indicate the solids content.

The following are components shown in Table 1.

(A-2): “Acrysol ASE-60” (trade name, produced by Dow Chemical Co., Ltd., polyacrylic acid-based rheology control agent, solids content: 28%)
(B-2): “Iriodin 111 Rutile Lustre Satin” (trade name, produced by Merck & Co., Inc., titanium oxide-coated natural mica pigment, average primary particle size: about 6 μm, average thickness: about 0.3 μm)
(B-3) “Metashine ST1018RS” (trade name, produced by Nippon Sheet Glass, titanium dioxide-coated glass flake pigment, average primary particle size: about 18 μm, average thickness: about 1.0 μm)
(B-4) “Xirallic (registered trademark) T60-20 Sunbeam Gold” (trade name, titanium oxide-coated alumina flake pigment, produced by Merck & Co., Inc., average primary particle size: about 18 μm, average thickness: about 0.4 μm)
(B-5) “Xirallic (registered trademark) T60-24 Stellar Green” (trade name, titanium oxide-coated alumina flake pigment, produced by Merck & Co., Inc., average primary particle size: about 19 μm, average thickness: about 0.6 μm)
(B-6) “Xirallic (registered trademark) T60-25 Cosmic Turquoise” (trade name, titanium oxide-coated alumina flake pigment, produced by Merck & Co., Inc., average primary particle size: about 20 μm, average thickness: about 0.9 μm)

TABLE 1

| | | | | Production Example No. | | | | | | | | |
|---|---|---|---|---|---|---|---|---|---|---|---|---|
| | | | | 16 | 17 | 18 | 19 | 20 | 21 | 22 | 23 | 24 |
| Name of effect pigment dispersion (Y) | | | | Y-1 | Y-2 | Y-3 | Y-4 | Y-5 | Y-6 | Y-7 | Y-8 | Y-9 |
| Formula- | Distilled water | | | 40 | 40 | 40 | 40 | 40 | 40 | 40 | 40 | 97.9 |
| tion | Rheology | A-1 | “Rheocrysta” | 0.3 | 0.3 | 0.3 | 0.3 | 0.3 | 0.3 | 0.3 | 0.3 | |
| | control | A-2 | “ASE-60” | | | | | | | | | 2.5 |
| | agent (A) | | | | | | | | | | | |
| | Flake- | B-1 | Xirallic T60-10 | 1.3 | | | | | | | 1.3 | 1.3 |
| | effect | | Crystal Silver | | | | | | | | | |
| | pigment | B-2 | Iriodin 111 | | 1.3 | | | | | | | |
| | (B) | B-3 | Metashine | | | 1.3 | | | | | | |
| | | | ST1018RS | | | | | | | | | |
| | | B-4 | Xirallic T60-20 | | | | 1.3 | | | 1.3 | | |
| | | | Sunbeam Gold | | | | | | | | | |
| | | B-5 | Xirallic T60-24 | | | | | 1.3 | | | | |
| | | | Stellar Green | | | | | | | | | |
| | | B-6 | Xirallic T60-25 | | | | | | 1.3 | | | |
| | | | Cosmic Turquoise | | | | | | | | | |
| | Yellow | Yellow pigment | “Yellow 2GLMA” | | | | | | | 1.3 | 1.3 | |
| | pigment | dispersion (P-2) | Acrylic resin (R-2) | | | | | | | 0.26 | 0.26 | |
| | Resin | Acrylic resin | (R-1) | | | | | | | | | 240 |
| | | aqueous dispersion | | | | | | | | | | |
| | | Melamine resin | “Cymel 250” | | | | | | | | | 42.9 |
| | | Polyester resin | (R-3) | | | | | | | | | 14.3 |
| | Surface | C-1 | “BYK348” | 0.5 | 0.5 | 0.5 | 0.5 | 0.5 | 0.5 | 0.5 | 0.5 | 0.5 |
| | adjusting | | | | | | | | | | | |
| | agent (C) | | | | | | | | | | | |

| | | | | | | | | | | |
|---|---|---|---|---|---|---|---|---|---|---|
| | Dimethylethanolamine | | | | | | | | | 0.6 |
| | Ethylene glycol monobutyl ether | 0.5 | 0.5 | 0.5 | 0.5 | 0.5 | 0.5 | 0.5 | 0.5 | 10 |
| Proper- | Solids content (%) | 2.1 | 2.1 | 2.1 | 2.1 | 2.1 | 2.1 | 3.5 | 3.5 | 25 |
| ties | Paint viscosity B60 value (mPa · s) | 200 | 200 | 200 | 200 | 200 | 200 | 200 | 200 | 800 |
| | Amount of effect pigment (B) when the solids | 61.9 | 61.9 | 61.9 | 61.9 | 61.9 | 61.9 | 37.1 | 37.1 | 1.3 |
| | content of effect pigment dispersion (Y) is defined | | | | | | | | | |
| | as 100 parts by mass (parts by mass) | | | | | | | | | |
| | Amount of effect pigment (B) when the total amount | 1.3 | 1.3 | 1.3 | 1.3 | 1.3 | 1.3 | 1.2 | 1.2 | 0.3 |
| | of effect pigment dispersion (Y) is defined as 100 | | | | | | | | | |
| | parts by mass (parts by mass) | | | | | | | | | |

For distilled water, dimethylethanolamine, and ethyl glycol monobutyl ether, the liquid amount is shown; for the others, the solids content is shown.

### Preparation of Clear Paint (Z)

### Clear Paint (Z-1)

“KINO6510” (trade name, produced by Kansai Paint Co., Ltd., hydroxy-/isocyanate-curable acrylic resin/urethane resin-based two-component organic solvent-based paint) was used as a clear paint (Z-1).

### Clear Paint (Z-2)

“Magicron TC-69” (trade name: Kansai Paint Co., Ltd., acrylic and melamine resin-based one-component organic solvent-based paint) was used as a clear paint (Z-2).

### Preparation of Substrate

### Substrate 1

“Elecron 9400HB” cationic electrodeposition paint (trade name, produced by Kansai Paint Co., Ltd., an amine-modified epoxy resin-based cationic resin containing a blocked polyisocyanate compound as a curing agent) was applied by electrodeposition to a degreased and zinc phosphate-treated steel plate (JISG3141, size: 400×300×0.8 mm) to a cured film thickness of 20 μm. The resulting film was heated at 170° C. for 20 minutes to be cured by crosslinking, thereby obtaining substrate 1.

### Substrate 2

TP-65 white intermediate paint (product name: Kansai Paint Co., Ltd., a polyester resin solvent-based intermediate paint, L* value of the obtained coating film: 85) was electrostatically applied to substrate 1 to a cured film thickness of 35 μm using a rotary-atomization bell-shaped coater; and the resulting film was heated at 140° C. for 30 minutes to be cured by crosslinking, thereby obtaining substrate 2.

### Preparation of Test Plate

### Example 1

Step (1): The yellow intermediate paint (X-1) was electrostatically applied to substrate 1 to a cured film thickness of 25 μm with a rotary-atomization bell-shaped coater, and the resulting film was allowed to stand for 3 minutes to form a yellow coating film.

Step (2): Subsequently, the effect pigment dispersion (Y-1) prepared as described above was adjusted to a paint viscosity shown in Table 1, and applied to the yellow coating film to a dry film thickness of 1.0 μm using a Robot Bell (produced by ABB) at a booth temperature of 23° C. and at a humidity of 68%, and then allowed to stand for 3 minutes. Thereafter, the resulting coating was preheated at 80° C. for 3 minutes to form an effect coating film.

Step (3): Further, the clear paint (Z-1) was applied to the effect coating film to a dry film thickness of 35 μm using a Robot Bell (produced by ABB) at a booth temperature of 23° C. and at a humidity of 68% to form a clear coating film.

Step (4): After the coating, the resulting coated substrate was allowed to stand at room temperature for 7 minutes and then heated in a hot-air circulation drying oven at 140° C. for 30 minutes to simultaneously dry the multilayer coating film, thus forming a test plate.

The film thickness of the dry coating film shown in Table 2 was calculated from the following Formula 3. The same applies to the following Examples.

x=(sc*10000)/(S*sg) (Formula 3)

x: film thickness (μm)
sc: coating solids content (g)
S: evaluation area of coating solids content (cm²)
sg: coating film specific gravity (g/cm³)

### Examples 2 to 12 and Comparative Examples 1 to 5

Test plates were obtained in the same manner as in Example 1, except that the substrate, the yellow paint (X), effect pigment dispersion (Y), and dry film thickness of the yellow coating film were changed as shown in Table 2.

TABLE 2

| | Example | | | | | | | | | | | | Comparative Example | | | | |
|---|---|---|---|---|---|---|---|---|---|---|---|---|---|---|---|---|---|
| | 1 | 2 | 3 | 4 | 5 | 6 | 7 | 8 | 9 | 10 | 11 | 12 | 1 | 2 | 3 | 4 | 5 |
| Substrate | 1 | 1 | 1 | 1 | 1 | 1 | 1 | 1 | 2 | 1 | 1 | 1 | 1 | 1 | 1 | 1 | 1 |
| name | | | | | | | | | | | | | | | | | |
| Name of | X-1 | X-1 | X-1 | X-1 | X-1 | X-1 | X-1 | X-1 | X-1 | X-1 | X-4 | X-3 | X-7 | X-4 | X-1 | X-7 | X-7 |
| yellow | | | | | | | | | | | | | | | | | |
| paint (X) | | | | | | | | | | | | | | | | | |
| Film | 25 | 25 | 25 | 25 | 25 | 25 | 25 | 25 | 25 | 35 | 30 | 35 | 38 | 25 | 25 | 3 | 100 |
| thickness of | | | | | | | | | | | | | | | | | |
| yellow | | | | | | | | | | | | | | | | | |
| coating film | | | | | | | | | | | | | | | | | |
| (μm) | | | | | | | | | | | | | | | | | |
| Name of | Y-1 | Y-2 | Y-3 | Y-4 | Y-5 | Y-6 | Y-7 | Y-8 | Y-1 | Y-1 | Y-1 | Y-1 | Y-1 | Y-1 | Y-9 | Y-1 | Y-1 |
| effect | | | | | | | | | | | | | | | | | |
| pigment | | | | | | | | | | | | | | | | | |
| dispersion | | | | | | | | | | | | | | | | | |
| (Y) | | | | | | | | | | | | | | | | | |
| Optical | 2500 | 2500 | 2500 | 2500 | 2500 | 2500 | 2500 | 2500 | 2500 | 3500 | 840 | 4200 | 7600 | 700 | 2500 | 2500 | 600 |
| density of | | | | | | | | | | | | | | | | | |
| yellow | | | | | | | | | | | | | | | | | |
| pigment in | | | | | | | | | | | | | | | | | |
| yellow | | | | | | | | | | | | | | | | | |
| coating film | | | | | | | | | | | | | | | | | |
| HG value | 38 | 20 | 45 | 38 | 38 | 38 | 35 | 35 | 38 | 38 | 38 | 38 | 38 | 38 | 70 | 20 | 38 |
| Y5 | 600 | 400 | 250 | 550 | 450 | 450 | 500 | 500 | 600 | 600 | 500 | 600 | 600 | 450 | 150 | 450 | 600 |
| h value | 94 | 94 | 94 | 94 | 85 | 90 | 95 | 95 | 94 | 94 | 108 | 95 | 95 | 115 | 94 | 125 | 94 |
| CS value | 104 | 104 | 104 | 106 | 104 | 104 | 110 | 110 | 114 | 114 | 92 | 120 | 120 | 79 | 104 | 50 | 104 |
| represented | | | | | | | | | | | | | | | | | |
| by formula 1 | | | | | | | | | | | | | | | | | |
| Anti-water | A | A | A | A | A | A | A | A | A | B | A | B | C | A | A | A | A |
| adhesion | | | | | | | | | | | | | | | | | |

### Example 13

Step (1): The yellow intermediate paint (X-1) was electrostatically applied to substrate 1 to a cured film thickness of 25 μm with a rotary-atomization bell-shaped coater, and heated at 140° C. for 30 minutes to be cured by crosslinking, thus forming a yellow coating film.

Step (2): Subsequently, the transparent base paint (W-1) was applied to the obtained yellow coating film to a dry film thickness of 10 μm using a rotary-atomization bell-shaped coater, and then allowed to stand for 2 minutes.

Step (3): The effect pigment dispersion (Y-1) was adjusted to the paint viscosity shown in Table 1 and further applied to the effect coating film to a dry film thickness of 1.0 μm using a Robot Bell (produced by ABB) at a booth temperature of 23° C. and at a humidity of 68% to form an effect coating film, and then allowed to stand at 30° C. for 3 minutes.

Step (4): Subsequently, the clear paint (Z-1) was applied to the obtained dry coating film to a dry film thickness of 35 μm using a Robot Bell (produced by ABB) at a booth temperature of 23° C. and at a humidity of 68% to form a clear coating film.

Step (5): After the coating, the resulting coated substrate was allowed to stand at room temperature for 7 minutes and then heated in a hot-air circulation drying oven at 140° C. for 30 minutes to simultaneously dry the multilayer coating films, thus forming a test plate.

### Examples 14 to 23 and Comparative Examples 6 to 8

Test plates were obtained in the same manner as in Example 13, except that the substrate, yellow paint (X), effect pigment dispersion (Y), and dry film thickness of the yellow coating film were changed as shown in Table 3.

TABLE 3

| | | | | | | | | | | | | Comparative | | |
|---|---|---|---|---|---|---|---|---|---|---|---|---|---|---|
| | Example | | | | | | | | | | | Example | | |
| | 13 | 14 | 15 | 16 | 17 | 18 | 19 | 20 | 21 | 22 | 23 | 6 | 7 | 8 |
| Substrate name | 1 | 1 | 1 | 1 | 1 | 1 | 1 | 1 | 2 | 1 | 1 | 1 | 1 | 1 |
| Name of yellow | X-1 | X-1 | X-1 | X-1 | X-1 | X-1 | X-1 | X-1 | X-1 | X-1 | X-4 | X-7 | X-4 | X-1 |
| paint (X) | | | | | | | | | | | | | | |
| Film thickness of | 25 | 25 | 25 | 25 | 25 | 25 | 25 | 25 | 25 | 35 | 30 | 38 | 25 | 25 |
| yellow coating | | | | | | | | | | | | | | |
| film (μm) | | | | | | | | | | | | | | |
| Name of effect | Y-1 | Y-2 | Y-3 | Y-4 | Y-5 | Y-6 | Y-7 | Y-8 | Y-1 | Y-1 | Y-1 | Y-1 | Y-1 | Y-9 |
| pigment | | | | | | | | | | | | | | |
| dispersion (Y) | | | | | | | | | | | | | | |
| Optical density | 2500 | 2500 | 2500 | 2500 | 2500 | 2500 | 2500 | 2500 | 2500 | 3500 | 840 | 7600 | 700 | 2500 |
| of yellow pigment | | | | | | | | | | | | | | |
| in yellow coating | | | | | | | | | | | | | | |
| film | | | | | | | | | | | | | | |
| HG value | 43 | 25 | 50 | 43 | 43 | 43 | 40 | 40 | 43 | 43 | 43 | 43 | 43 | 70 |
| Y5 | 550 | 350 | 200 | 500 | 400 | 400 | 450 | 450 | 550 | 550 | 450 | 550 | 400 | 150 |
| h value | 94 | 94 | 94 | 94 | 85 | 90 | 95 | 95 | 94 | 94 | 108 | 95 | 115 | 94 |
| CS value | 104 | 104 | 104 | 106 | 104 | 104 | 110 | 110 | 114 | 114 | 92 | 120 | 79 | 104 |
| represented by | | | | | | | | | | | | | | |
| formula (1) | | | | | | | | | | | | | | |
| Anti-water | A | A | A | A | A | A | A | A | A | B | A | C | A | A |
| adhesion | | | | | | | | | | | | | | |

### Example 24

Step (1): The yellow base paint (X-2) was electrostatically applied to substrate 2 to a cured film thickness of 15 μm with a rotary-atomization bell-shaped coater, and then allowed to stand for 3 minutes to form a yellow coating film.

Step (2): Subsequently, the effect pigment dispersion (Y-1) prepared as described above was adjusted to the paint viscosity as shown in Table 1 and applied to the yellow coating film to a dry film thickness of 1.0 μm using a Robot Bell (produced by ABB) at a booth temperature of 23° C. and at a humidity of 68%, and then allowed to stand for 3 minutes. Thereafter, the resulting coating was preheated at 80° C. for 3 minutes to form an effect coating film.

Step (3): Further, the clear paint (Z-1) was applied to the effect coating film to a dry film thickness of 35 μm using a Robot Bell (produced by ABB) at a booth temperature of 23° C. and at a humidity of 68% to form a clear coating film.

Step (4): After the coating, the resulting coated substrate was allowed to stand at room temperature for 7 minutes and then heated in a hot-air circulation drying oven at 140° C. for 30 minutes to simultaneously dry the multilayer coating film, thus forming a test plate.

The film thickness of each dry coating film shown in Table 2 was calculated from the formula shown. The same applies to the following Examples.

### Examples 25 to 26 and Comparative Examples 9 to 11

Test plates were obtained in the same manner as in Example 24, except that the yellow paint (X), effect pigment dispersion (Y), and dry film thickness of the yellow coating film were changed as shown in Table 4.

TABLE 4

| | | | | Comparative | | |
|---|---|---|---|---|---|---|
| | Example | | | Example | | |
| | 24 | 25 | 26 | 9 | 10 | 11 |
| Name of yellow paint (X) | X-2 | X-5 | X-2 | X-8 | X-6 | X-2 |
| Film thickness of yellow | 15 | 15 | 10 | 26 | 10 | 25 |
| coating film (μm) | | | | | | |
| Name of effect pigment | Y-1 | Y-1 | Y-1 | Y-1 | Y-1 | Y-9 |
| dispersion (Y) | | | | | | |
| Optical density of yellow | 1125 | 3000 | 750 | 7800 | 700 | 1125 |
| pigment in yellow coating | | | | | | |
| film | | | | | | |
| Hg value | 43 | 43 | 43 | 43 | 43 | 70 |
| Y5 | 550 | 550 | 450 | 550 | 400 | 150 |
| h value | 94 | 94 | 110 | 95 | 110 | 94 |
| CS value represented by | 95 | 104 | 90 | 120 | 79 | 104 |
| formula 1 | | | | | | |
| Anti-water adhesion | A | A | A | C | A | A |

### Example 27

Step (1): The yellow intermediate paint (X-1) was electrostatically applied to substrate 1 to a cured film thickness of 35 μm with a rotary-atomization bell-shaped coater; and heated at 140° C. for 30 minutes to be cured by crosslinking, thus forming a first-layer yellow coating film. Subsequently, the yellow intermediate paint (W-1) was applied to the first-layer yellow coating film to a cured film thickness of 35 μm using a rotary-atomization bell-shaped coater, and heated at 140° C. for 30 minutes to be cured by crosslinking, thus forming a second-layer yellow coating film.

Step (2): Subsequently, the transparent base paint (W-1) was electrostatically applied to the obtained yellow coating film to a cured film thickness of 10 μm using a rotary-atomization bell-shaped coater, and allowed to stand for 2 minutes.

Step (3): The effect pigment dispersion (Y-1) was adjusted to the paint viscosity shown in Table 1 and further applied to the coating film to a dry film thickness of 1.0 μm using a Robot Bell (produced by ABB) at a booth temperature of 23° C. and at a humidity of 68% to form an effect coating film, and then allowed to stand at 80° C. for 3 minutes.

Step (4): Subsequently, the clear paint (Z-1) was applied to the effect coating film to a dry film thickness of 35 μm using a Robot Bell (produced by ABB) at a booth temperature of 23° C. and at a humidity of 68% to form a clear coating film.

Step (5): After the coating, the resulting coated substrate was allowed to stand at room temperature for 7 minutes and then heated in a hot-air circulation drying oven at 140° C. for 30 minutes to simultaneously dry the multilayer coating film, thus forming a test plate.

### Example 28

A test plate was obtained in the same manner as in Example 27, except that the yellow medium paint (X-4) was used instead of the yellow medium paint (X-1), and the dry coating film thickness of the first-layer yellow coating film and that of the second-layer yellow coating film were both 25 μm.

### Example 29

Step (1): The yellow intermediate paint (X-1) was electrostatically applied to substrate 2 to a cured film thickness of 35 μm with a rotary-atomization bell-shaped coater; and heated at 140° C. for 30 minutes to be cured by crosslinking, thus forming a first-layer yellow coating film. Subsequently, the yellow base paint (X-2) was applied to the first-layer yellow coating film to a cured film thickness of 10 μm using a rotary-atomization bell-shaped coater, and allowed to stand for 2 minutes to form a second-layer yellow coating film.

Step (2): Subsequently, the effect pigment dispersion (Y-1) was adjusted to the paint viscosity shown in Table 1 and applied to the yellow coating film to a dry film thickness of 1.0 μm using a Robot Bell (produced by ABB) at a booth temperature of 23° C. and at a humidity of 68%, and then allowed to stand for 3 minutes. Thereafter, the resulting coating was preheated at 80° C. for 3 minutes to form an effect coating film.

Step (3): Further, the clear paint (Z-1) was applied to the effect coating film to a dry film thickness of 35 μm using a Robot Bell (produced by ABB) at a booth temperature of 23° C. and at a humidity of 68%, thus forming a clear coating film.

Step (4): After the coating, the resulting coated substrate was allowed to stand at room temperature for 7 minutes and then heated in a hot-air circulation drying oven at 140° C. for 30 minutes to simultaneously dry the multilayer coating film, thus forming a test plate.

The film thickness of each dry coating film shown in Table 2 was calculated according to the formula shown. The same applies to the following Examples.

### Example 30

Step (1): The yellow base paint (X-2) was electrostatically applied to substrate 2 to a cured film thickness of 15 μm with a rotary-atomization bell-shaped coater, and allowed to stand for 3 minutes to form a first-layer yellow coating film. Subsequently, the clear paint (Z-2) was applied to the first-layer yellow coating film to a dry film thickness of 25 μm using a Robot Bell (produced by ABB) at a booth temperature of 23° C. and at a humidity of 68% to form a clear coating film. Further, the yellow base paint (X-2) was electrostatically applied to the clear paint to a cured film thickness of 10 μm with a rotary-atomization bell-shaped coater, and allowed to stand for 2 minutes to form a second-layer yellow coating film.

Step (2): Subsequently, the effect pigment dispersion (Y-1) prepared as described above was adjusted to a paint viscosity shown in Table 1 and applied to the coating film to a dry film thickness of 1.0 μm using a Robot Bell (produced by ABB) at a booth temperature of 23° C. and at a humidity of 68% and then allowed to stand for 3 minutes. Thereafter, the resulting coating was preheated at 80° C. for 3 minutes to form an effect coating film.

Step (3): Further, the clear paint (Z-1) was applied to the effect coating film to a dry film thickness of 35 μm using a Robot Bell (produced by ABB) at a booth temperature of 23° C. and at a humidity of 68% to form a clear coating film.

Step (4): After the coating, the resulting coated substrate was allowed to stand at room temperature for 7 minutes, and then heated in a hot-air circulation drying oven at 140° C. for 30 minutes to simultaneously dry the multilayer coating film, thus forming a test plate.

### Example 31

Step (1): The yellow intermediate paint (X-1) was electrostatically applied to substrate 1 to a cured film thickness of 35 μm with a rotary-atomization bell-shaped coater, and heated at 140° C. for 30 minutes to be cured by crosslinking, thus forming a first-layer yellow coating film. Subsequently, the yellow base paint (X-2) was applied to the first-layer yellow coating film to a cured film thickness of 15 μm using a rotary-atomization bell-shaped coater, and allowed to stand for 3 minutes to form a second-layer yellow coating film. Subsequently, the clear paint (Z-2) was applied to the first-layer yellow coating film to a dry film thickness of 25 μm using a Robot Bell (produced by ABB) at a booth temperature of 23° C. and at a humidity of 68% to form a clear coating film. Further, the yellow base paint (X-2) was applied to the clear coating film to a cured film thickness of 10 μm using a rotary-atomization bell-shaped coater, and allowed to stand for 2 minutes to form a third-layer yellow coating film.

Step (2): Subsequently, the effect pigment dispersion (Y-1) prepared as described above was adjusted to the paint viscosity shown in Table 1, and applied to the coating film to a dry film thickness of 1.0 μm using a Robot Bell (produced by ABB) at a booth temperature of 23° C. and at a humidity of 68%, and then allowed to stand for 3 minutes. Thereafter, the resulting coating was preheated at 80° C. for 3 minutes to form an effect coating film.

Step (3): Further, the clear paint (Z-1) was applied to the effect coating film to a dry film thickness of 35 μm using a Robot Bell (produced by ABB) at a booth temperature of 23° C. and at a humidity of 68% to form a clear coating film.

Step (4): After the coating, the resulting coated substrate was allowed to stand at room temperature for 7 minutes, and then heated in a hot-air circulation drying oven at 140° C. for 30 minutes to simultaneously dry the multilayer coating film, thus forming a test plate.

### Evaluation of Coating Film

The appearance and performance of the coating film of each test plate obtained in the above manner were evaluated. Tables 2 to 5 show the results.

The coating appearance was evaluated based on luminance (Y5 value), graininess (HG value), hue angle (h value), and CS value represented by formula 1.

### Graininess

The graininess was evaluated in terms of the hi-light graininess value (hereinafter abbreviated as the “HG value”). The HG value is an indicator of microscopic brilliance obtained by the microscopic observation of a coating surface, and indicates the graininess in the highlight. The HG value is calculated as follows. First, the coating surface is photographed with a CCD camera at a light incidence angle of 15° and a receiving angle of 0°, and the obtained digital image data (two-dimensional luminance distribution data) is subjected to a two-dimensional Fourier transform to obtain a power spectrum image. Subsequently, only the spatial frequency area corresponding to graininess is extracted from the power spectrum image; and the obtained measurement parameter is converted to a numerical value from 0 to 100 that has a linear relation with graininess, thus obtaining an HG value. An HG value of 0 indicates no graininess of the effect pigment at all, and an HG value of 100 indicates the highest possible graininess of the effect pigment. A low graininess is preferable in terms of pearl luster.

### Luminance (Y5 Value)

The luminance value (Y5) in the XYZ color space was calculated based on a spectral reflectance of light illuminated at an angle of 45 degrees with respect to the coating film and received at an angle of 5 degrees deviated from the specular reflection light in the incident light direction. The measurement and the calculation were performed using a GCMS-4 Goniometer (trade name, produced by Murakami Color Research Laboratory, Co., Ltd.). A Y5 value of 200 or more is preferable in terms of pearl luster.

### Hue Angle (h Value)

The hue angle h in the L*C*h color space, calculated based on the spectral reflectance of light illuminated at an angle of 45 degrees with respect to the coating film and received at an angle of 45 degrees deviated from the specular reflection light, was determined using a multi-angle spectrophotometer (trade name: MA-68II, produced by X-Rite Inc.).

### CS Value

The CS value was calculated by extrapolating, to formula 1, the numerical value of luminance L*110 and the numerical value of chroma C*110 in the L*C*h color space calculated based on the spectral reflectance of light illuminated at an angle of 45 degrees with respect to the coating film and received at an angle of 110 degrees deviated from the specular reflection light. The spectroscopic reflectance was measured using a multi-angle spectrophotometer (trade name: MA-68II, produced by X-Rite Inc.).

CS=[(L*110)²+(C*110)²]^{1/2} (Formula 1)

The coating film performance was evaluated in terms of anti-water adhesion.

### Anti-Water Adhesion

The test plates were immersed in warm water at 40° C. for 240 hours, and then drawn out. Water droplets and dirt were wiped away with a cloth, and cross-cuts that reached the substrate of each test plate were made to form a grid of 100 squares (2 mm×2 mm) on the multilayer coating film of the plate with a utility knife at a room temperature of 23° C. within 10 minutes. Subsequently, an adhesive cellophane tape was applied to the surface of the grid portion, and then abruptly peeled off. The condition of the remaining grid-formed coating film was examined, and water resistance was evaluated in accordance with the following criteria. A grade of C is denoted as unacceptable.

A: 100 squares of the grid of the coating film remained, and no edge-peeling occurred at the edge of cuts made by the knife.
B: 100 squares of the grid of the coating film remained, but slight edge-peeling occurred at the edge of cuts made by the knife.
C: The number of remaining squares of the grid of the coating film was 99 or less.

TABLE 5

| | Example | | | | |
|---|---|---|---|---|---|
| | 27 | 28 | 29 | 30 | 31 |
| Substrate | 1 | 1 | 2 | 2 | 1 |
| Name of yellow | X-1 | X-4 | X-1 | X-2 | X-1 |
| paint (X) | X-1 | X-4 | X-2 | X-2 | X-2 |
| | | | | | X-2 |
| Film thickness | 35 plus | 25 plus | 35 plus | 15 plus | 35 plus |
| of yellow | 35 | 25 | 10 | 10 | 15 plus |
| coating film | | | | | 10 |
| (μm) | | | | | |
| Name of effect | Y-1 | Y-1 | Y-1 | Y-1 | Y-1 |
| pigment | | | | | |
| dispersion (Y) | | | | | |
| Optical | 7000 | 1400 | 4250 | 1875 | 5375 |
| density of | | | | | |
| yellow pigment | | | | | |
| in yellow | | | | | |
| coating film | | | | | |
| HG value | 43 | 43 | 38 | 38 | 38 |
| Y5 | 550 | 550 | 600 | 600 | 600 |
| h value | 90 | 92 | 90 | 94 | 90 |
| CS value | 120 | 100 | 120 | 114 | 120 |
| represented by | | | | | |
| formula 1 | | | | | |
| Anti-water | A | A | A | A | A |
| adhesion | | | | | |

The embodiments of the present invention and Examples thereof are described in detail above. However, the present invention is not limited to the above embodiments, and various modifications can be made based on the technical idea of the present invention.

1. A method for forming a multilayer coating film, comprising:
(1) applying a yellow pigment-containing paint (X) to a substrate to form at least one layer of a yellow coating film;
(2) applying an effect pigment dispersion (Y) to the yellow coating film to form an effect coating film;
(3) applying a clear paint (Z) to the effect coating film to form a clear coating film; and
(4) heating the yellow coating film, the effect coating film, and the clear coating film to separately or simultaneously cure the coating films,
wherein the yellow pigment contained in the yellow coating film has an optical density of 750 to 7000, wherein the optical density is a value obtained by multiplying the pigment concentration by the film thickness,
the effect pigment dispersion (Y) contains water, a rheology control agent (A), and an interference flake-effect pigment (B),
the multilayer coating film has an h value of 60 to 120°,
the multilayer coating film has a Y5 value of 200 or more, and
the multilayer coating film has a CS value of 90 or more, wherein the CS value is expressed by Equation 1:
CS=[(L*110)²+(C*110)²]^{1/2} (Equation 1).

2. The method for forming a multilayer coating film according to claim 1, wherein the measurement value of graininess (HG value) is 60 or less.

3. The method for forming a multilayer coating film according to claim 1, wherein the yellow pigment contains bismuth vanadate.

4. The method for forming a multilayer coating film according to claim 1, wherein the rheology control agent (A) is a cellulose nanofiber.

5. The method for forming a multilayer coating film according to claim 1, wherein the interference flake-effect pigment (B) is one or more pigments whose interference color is selected from an achromatic color, gold, and green.

6. The method for forming a multilayer coating film according to claim 1, wherein the clear paint (Z) is a two-component clear paint containing a hydroxy-containing resin and a polyisocyanate compound.

7. A multilayer coating film to be formed on a substrate, comprising:
at least one layer of a yellow coating film containing a yellow pigment;
an effect coating film formed on the yellow coating film; and
a clear coating film formed on the effect coating film,
wherein the yellow pigment contained in the yellow coating film has an optical density of 750 to 7000, wherein the optical density is a value obtained by multiplying the pigment concentration by the film thickness,
the effect coating film contains a rheology control agent (A) and an interference flake-effect pigment (B),
the multilayer coating film has an h value of 60 to 120°,
the multilayer coating film has a Y5 value of 200 or more, and
the multilayer coating film has a CS value of 90 or more, wherein the CS value is expressed by Equation 1:
CS=[(L*110)²+(C*110)²]^{1/2} (Equation 1).

8. The multilayer coating film according to claim 7, wherein the measurement value of graininess (HG value) is 60 or less.

9. The multilayer coating film according to claim 7, wherein the yellow pigment contains bismuth vanadate.

10. The multilayer coating film according to claim 7, wherein the rheology control agent (A) is a cellulose nanofiber.

11. The multilayer coating film according to claim 7, wherein the interference flake-effect pigment (B) is one or more pigments whose interference color is selected from an achromatic color, gold, and green.

12. The multilayer coating film according to claim 7, wherein the clear coating film is obtained by applying a two-component clear paint containing a hydroxy-containing resin and a polyisocyanate compound.
